(19) United States
(12) Patent Application Publication
(10) Pub. No.: US 2026/0296916 A1
(43) Pub. Date: Oct. 1, 2026

(54) METHOD FOR FORMING POSITIVE ELECTRODE ACTIVE MATERIAL PARTICLE

(71) Applicant: SEMICONDUCTOR ENERGY LABORATORY CO., LTD., Atsugi-shi (JP)

(72) Inventors: Masahiro TAKAHASHI, Atsugi (JP); Takashi HIRAHARA, Atsugi (JP); Toshihiro NAKAMURA, Atsugi (JP); Kousuke SASAKI, Atsugi (JP)

(21) Appl. No.: 19/630,106

(22) Filed: Mar. 26, 2026

(30) Foreign Application Priority Data
Mar. 28, 2025 (JP) 2025-055623

(51) Int. Cl. C01G 53/502; H01M 4/02; H01M 4/36; H01M 4/505; H01M 4/58

(52) U.S. Cl. CPC C01G 53/502; H01M 4/364; H01M 4/505; H01M 4/582; C01P 2006/40; H01M 2004/028

(57) ABSTRACT

A method for forming a lithium-rich positive electrode active material particle which enables high charge and discharge capacities and has a stable crystal structure is provided. The method for forming the positive electrode active material particle includes the steps of: mixing a lithium source and an M source (M is one or more selected from Mn, Ni, Co, Cr, Mo, Nb, V, Fe, Ti, and Ru) to form a first mixture; heating the first mixture at higher than or equal to 850° C. and lower than 950° C. to synthesize a first composite oxide; mixing the first composite oxide and an additive element source to form a second mixture; and heating the second mixture at higher than or equal to 850° C. and lower than or equal to 950° C. The additive element source includes a fluorine source and a magnesium source.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a positive electrode active material particle; a power storage device, a semiconductor device, a display device, a light-emitting device, a lighting device, or an electronic device each including a secondary battery; or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices, such as lithium-ion secondary batteries, lithium-ion capacitors, and air batteries, have been actively developed. In particular, demand for lithium-ion secondary batteries with high output and high energy density has rapidly grown with the development of the semiconductor industry, for portable information terminals typified by mobile phones, smartphones, or laptop computers, portable music players, digital cameras, medical equipment, and next-generation clean energy vehicles typified by hybrid electric vehicles (HVs), electric vehicles (EVs), and plug-in hybrid electric vehicles (PHVs), and the lithium-ion secondary batteries are essential as rechargeable energy supply sources for today's society.

As high-capacity positive electrode active materials of lithium-ion secondary batteries, lithium cobalt oxide (LiCoO₂), lithium nickel-cobalt-manganese oxide (LiNiₐCo_{b}Mn_{c}O₂, a+b+c=1), and the like each having a layered rock-salt crystal structure have been put into practical use.

Further research and development have been carried out to increase the capacity. Particular attention has been drawn to positive electrode active materials called lithium-rich or lithium-excess positive electrode active materials owing to their capabilities of storing much more lithium ions than conventional lithium cobalt oxide, lithium nickel-cobalt-manganese oxide, and the like (Non-Patent Documents 1 to 5).

### REFERENCES

### Non-Patent Documents

[Non-Patent Document 1] Hideyuki Koga et al., “Reversible Oxygen Participation to the Redox Processes Revealed for Li_{1.20}Mn_{0.54}Co_{0.13}Ni_{0.13}O₂”, Journal of The Electrochemical Society, 160 (6) A786-A792 (2013)
[Non-Patent Document 2] Jianming Zheng et al., “Functioning Mechanism of AlF₃ Coating on the Li- and Mn-Rich Cathode Materials”, Chemistry of Materials, 26, 6320-6327 (2014)
[Non-Patent Document 3] Jun Wang et al., “Lithium- and Manganese-Rich Oxide Cathode Materials for High-Energy Lithium Ion Batteries”, Advanced Energy Materials, 6, 1600906 (2016)
[Non-Patent Document 4] Wei He et al., “Challenges and Recent Advances in High Capacity Li-Rich Cathode Materials for High Energy Density Lithium-Ion Batteries”, Advanced Materials, 33, 2005937 (2021)
[Non-Patent Document 5] Zijian Cai et al., “In situ formed partially disordered phases as earth-abundant Mn-rich cathode materials”, Nature Energy (2023), https://doi.org/10.1038/s41560-023-01375-9

### SUMMARY OF THE INVENTION

Lithium-rich positive electrode active materials are known to have many advantages. For example, the discharge capacity per unit weight of such a positive electrode active material can be higher than or equal to 250 mAh/g, or even higher than or equal to 300 mAh/g. At the same time, the energy density per unit weight can be higher than or equal to 1000 Wh/kg, for example. Moreover, instead of cobalt having the issues of cost and the like, manganese, which is abundant and less expensive, can be used as a main transition metal.

On the other hand, lithium-rich positive electrode active materials have drawbacks such as a large decrease in initial discharge capacity with respect to initial charge capacity, a low rate performance, and a large decrease in voltage and/or discharge capacity in a charge and discharge cycle test. This is probably because lithium-rich positive electrode active material particles undergo a change in crystal structure and/or release of oxygen when lithium is extracted.

In addition, lithium-rich positive electrode active materials tend to have a high internal resistance with an increase in particle size in a heating step or the like during formation, resulting in decreases in charge and discharge capacities.

In view of the above, an object of one embodiment of the present invention is to provide a lithium-rich positive electrode active material particle or composite oxide which enables high charge and discharge capacities. Another object is to provide a lithium-rich positive electrode active material particle or composite oxide which is inhibited from having an increase in particle size. Another object is to provide a lithium-rich positive electrode active material particle or composite oxide which inhibits a decrease in initial discharge capacity with respect to initial charge capacity. Another object is to provide a lithium-rich positive electrode active material particle or composite oxide which enables a high rate performance. Another object is to provide a lithium-rich positive electrode active material particle or composite oxide which inhibits a decrease in voltage or discharge capacity during charge and discharge cycles. Another object is to provide a lithium-rich positive electrode active material particle or composite oxide which is inhibited from having a change in crystal structure during charging. Another object is to provide a lithium-rich positive electrode active material particle or composite oxide which is inhibited from releasing oxygen. Another object is to provide a secondary battery with high charge and discharge capacities, high safety, or high reliability.

Another object of one embodiment of the present invention is to provide a novel positive electrode active material particle, a novel composite oxide, a novel power storage device, or a formation or manufacturing method thereof.

Note that the description of these objects does not preclude the existence of other objects. One embodiment of the present invention does not need to achieve all these objects. Other objects can be derived from the description of the specification, the drawings, and the claims.

One embodiment of the present invention for achieving at least one of the above objects is a positive electrode active material particle having a core-shell structure, whose shell contains a large amount of an additive element such as magnesium. For effective doping of the shell with the additive element, a fluoride salt functioning as a fusing agent is used.

One embodiment of the present invention is a method for forming a positive electrode active material particle, including the steps of: mixing a lithium source and an M source (Mis one or more selected from Mn, Ni, Co, Cr, Mo, Nb, V, Fe, Ti, and Ru) to form a first mixture; heating the first mixture at higher than or equal to 850° C. and lower than 950° C. to synthesize a first composite oxide; mixing the first composite oxide and an additive element source to form a second mixture; and heating the second mixture at higher than or equal to 850° C. and lower than or equal to 950° C. The additive element source includes a fluorine source and a magnesium source.

In the above embodiment, the fluorine source is preferably lithium fluoride, and the magnesium source is preferably magnesium fluoride.

According to one embodiment of the present invention, a lithium-rich positive electrode active material particle or composite oxide which enables high charge and discharge capacities can be provided. Alternatively, a lithium-rich positive electrode active material particle or composite oxide with a small particle size can be provided. Alternatively, a lithium-rich positive electrode active material particle or composite oxide which inhibits a decrease in initial discharge capacity with respect to initial charge capacity can be provided. Alternatively, a lithium-rich positive electrode active material particle or composite oxide which enables a high rate performance can be provided. Alternatively, a lithium-rich positive electrode active material particle or composite oxide which inhibits a decrease in voltage or discharge capacity during charge and discharge cycles can be provided. Alternatively, a lithium-rich positive electrode active material particle or composite oxide which is inhibited from having a change in crystal structure during charging can be provided. Alternatively, a lithium-rich positive electrode active material particle or composite oxide which is inhibited from releasing oxygen can be provided. Alternatively, a secondary battery with high charge and discharge capacities, high safety, or high reliability can be provided.

According to another embodiment of the present invention, a novel positive electrode active material particle, a novel composite oxide, a novel power storage device, or a formation or manufacturing method thereof can be provided.

Note that the description of these effects does not preclude the existence of other effects. One embodiment of the present invention does not necessarily need to have all these effects. Other effects will be apparent from and can be derived from the description of the specification, the drawings, the claims, and the like.

### BRIEF DESCRIPTION OF THE DRAWINGS

FIG. 1 is a schematic cross-sectional view of a positive electrode active material particle of one embodiment of the present invention.

FIGS. 2A to 2C each illustrate a crystal structure of a positive electrode active material particle of one embodiment of the present invention.

FIGS. 3A and 3B each illustrate an example of a method for forming a positive electrode active material particle of one embodiment of the present invention.

FIG. 4 illustrates an example of a method for forming a positive electrode active material particle of one embodiment of the present invention.

FIGS. 5A to 5D each illustrate a positive electrode of one embodiment of the present invention.

FIGS. 6A and 6B each illustrate a lithium-ion secondary battery of one embodiment of the present invention.

FIGS. 7A to 7C illustrate a lithium-ion secondary battery of one embodiment of the present invention.

FIGS. 8A to 8D illustrate a lithium-ion secondary battery and a power storage system of one embodiment of the present invention.

FIGS. 9A to 9C illustrate a lithium-ion secondary battery of one embodiment of the present invention.

FIGS. 10A to 10C illustrate a lithium-ion secondary battery of one embodiment of the present invention.

FIGS. 11A to 11C illustrate an electric vehicle of one embodiment of the present invention.

FIGS. 12A to 12D illustrate transport vehicles of one embodiment of the present invention.

FIGS. 13A to 13C illustrate two-wheeled vehicles and the like of one embodiment of the present invention.

FIGS. 14A to 14D illustrate electronic devices and the like of one embodiment of the present invention.

FIGS. 15A to 15D illustrate examples of space equipment.

FIGS. 16A to 16D each show a scanning electron microscope (SEM) image of a positive electrode active material of one embodiment of the present invention.

FIGS. 17A to 17C show charge and discharge curves of a secondary battery of one embodiment of the present invention.

FIG. 18 is a graph showing a charge and discharge cycle performance of a secondary battery of one embodiment of the present invention.

### DETAILED DESCRIPTION OF THE INVENTION

Hereinafter, embodiment examples for carrying out the present invention will be described with reference to the drawings and the like. Note that the present invention should not be construed as being limited to the embodiment examples given below. Embodiments for carrying out the invention can be changed unless they deviate from the spirit of the present invention.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing a minus sign (−) in front of a number instead of placing a bar over the number. Furthermore, an individual direction that shows an orientation in crystal is denoted with “[ ]”, a set direction that shows all of the equivalent orientations is denoted with “< >”, an individual plane that shows a crystal plane is denoted with “( )”, and a set plane having equivalent symmetry is denoted with “{ }”. A trigonal system represented by the space group R-3m is generally represented by a composite hexagonal lattice for easy understanding of the structure. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, description including a simple term “positive electrode active material” or “positive electrode active material particle” explains a plurality of positive electrode active material particles in some cases and explains one positive electrode active material particle in other cases, depending on an analysis method or the like. For example, when description relates to line analysis by scanning transmission electron microscopy-energy dispersive X-ray spectroscopy (STEM-EDX), STEM-electron energy-loss spectroscopy (STEM-EELS), or electron diffraction, the description is made on one positive electrode active material particle unless otherwise specified. Meanwhile, when description relates to X-ray photoelectron spectroscopy (XPS), X-ray diffraction (XRD), various types of mass spectroscopy, or the like, the description is made on a plurality of positive electrode active material particles unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape. In addition, a simple term “particle” includes a primary particle and a secondary particle.

In the case where the features of positive electrode active material particles are described, not all the particles necessarily have the features. When 50% or more, preferably 70% or more, further preferably 90% or more of three or more randomly selected positive electrode active material particles have the later-described preferable features, for example, it can be said that an effect of improving the characteristics of a secondary battery including the positive electrode active material particles is sufficiently obtained.

The distribution of an element indicates the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

The space group of a crystal structure is identified by XRD, electron diffraction, neutron diffraction, or the like. Thus, in this specification and the like, belonging to a space group or being a space group can be rephrased as being identified as a space group.

In this specification and the like, a rock-salt crystal structure refers to a structure in which a cubic crystal structure is included and cations and anions are alternately arranged, or a crystal structure in which anions are arranged to form a cubic close-packed structure and cation occupy all the octahedral sites. The cations may be of one kind or a plurality of kinds, and the anions may be of one kind or a plurality of kinds. A cation or anion vacancy may exist.

In this specification and the like, a layered rock-salt crystal structure refers to a crystal structure in which anions are arranged to form a cubic close-packed structure and the anions and cations at the octahedron sites are alternately arranged as in a rock-salt crystal structure, and in which the cations are apparently of a plurality of kinds, and the cations of at least one kind are arranged to form a two-dimensional plane. A lithium-rich oxide or positive electrode having such a crystal structure can also be referred to as a layered lithium-rich oxide or positive electrode. The layered lithium-rich oxide or positive electrode can also be referred to as a lithium-rich layered oxide, a lithium-rich layered positive electrode, or the like. When lithium ions form a two-dimensional plane, lithium can be two-dimensionally diffused. Note that a defect such as a cation or anion vacancy may exist. The cubic close-packed structure of the anions is not necessarily consistent with the theory and may have a distortion depending on the kind and/or arrangement of cations.

In this specification and the like, a disordered rock-salt crystal structure refers to a crystal structure in which a cubic crystal structure is included, anions are arranged to form a cubic close-packed structure, and the anions and cations at the octahedron sites are alternately arranged as in a rock-salt crystal structure, and in which the cations are apparently of a plurality of kinds, and the cations are arranged randomly. The random arrangement of cations in a lithium-rich positive electrode active material particle means that each cation site has a substantially fixed ratio between the appearance frequencies of different cation species and there is no significant ratio difference between the cation sites. It means that there is no significant contrast difference between the cation sites in a high-angle annular dark field scanning TEM (HAADF-STEM) image, for example. Note that a defect such as a cation or anion vacancy may exist.

In this specification and the like, a spinel crystal structure refers to a crystal structure represented by a general formula AB₂O₄, in which a cubic crystal structure is included, anions are arranged to form a cubic close-packed structure, and cations are present at the octahedral and tetrahedral sites. The atomic ratio of cations at the octahedral sites to those at the tetrahedral sites is 2:1 but does not need to be exactly equal thereto and can be a:1 (a is greater than or equal to 1.9 and less than or equal to 2.1), for example. The spinel crystal structure is preferably determined, for example, from a STEM image, a TEM image, an electron diffraction pattern, a fast Fourier transform (FFT) pattern of a TEM image, an FFT pattern of a STEM image, STEM-EELS, or the like.

In each of the rock-salt, layered rock-salt, disordered rock-salt, and spinel crystal structures, anions are arranged to form a cubic close-packed structure. When the arrangement of anions is close to a cubic close-packed structure, the arrangement can be regarded as the cubic close-packed structure. The arrangement of anions forming the cubic close-packed structure refers to a state where anions in the second layer are positioned above voids between anions packed in the first layer, and anions in the third layer are placed at the positions that are right above the voids between the anions in the second layer and are not right above the anions in the first layer. Accordingly, anions do not necessarily form a cubic lattice structure. Actual crystals always have a defect and thus, analysis results are not necessarily consistent with the theory. For example, in an electron diffraction pattern or an FFT pattern of a TEM image or the like, a spot may appear in a position slightly different from a theoretical position. For example, anions may be regarded as forming a cubic close-packed structure when a difference in orientation from a theoretical position is 5° or less or 2.5° or less.

A positive electrode active material particle to which an additive element for increasing conductivity and/or an additive element for stabilizing a crystal structure are/is added is sometimes referred to as a composite oxide, a positive electrode member, a positive electrode material, a secondary battery positive electrode member, or the like. The positive electrode active material particle of one embodiment of the present invention preferably contains a compound. The positive electrode active material particle of one embodiment of the present invention preferably contains a composition. The positive electrode active material particle of one embodiment of the present invention preferably contains a composite. The composite oxide refers to an oxide including a plurality of kinds of cations. The composite oxide includes anions of, but not limited only to, oxygen and may include anions of another element such as fluorine or chlorine in addition to oxygen anions.

The voltage of a positive electrode generally increases with increasing charge voltage of a secondary battery. The positive electrode active material particle of one embodiment of the present invention has a stable crystal structure even at a high voltage. The stable crystal structure of the positive electrode active material particle in a charged state can inhibit decreases in charge and discharge capacities due to repeated charging and discharging.

Note that the description is made on the assumption that materials (such as a positive electrode active material, a negative electrode active material, an electrolyte, and a separator) of a secondary battery have not deteriorated unless otherwise specified. A decrease in discharge capacity due to aging treatment and/or burn-in treatment during the manufacturing process of a secondary battery is not regarded as deterioration. For example, a state where discharge capacity is higher than or equal to 97% of the rated capacity of a lithium-ion secondary battery cell and an assembled lithium-ion secondary battery (hereinafter referred to as a lithium-ion secondary battery) can be regarded as a non-deteriorated state. The rated capacity conforms to the Japanese Industrial Standard (JIS) C 8711:2019 in the case of a lithium-ion secondary battery for a portable device. The rated capacities of other lithium-ion secondary batteries conform to the JIS described above, JIS for electric vehicle propulsion, industrial use, and the like, standards defined by the International Electrotechnical Commission (IEC), and the like.

### Embodiment 1

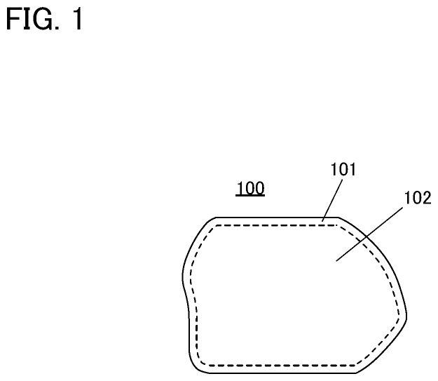

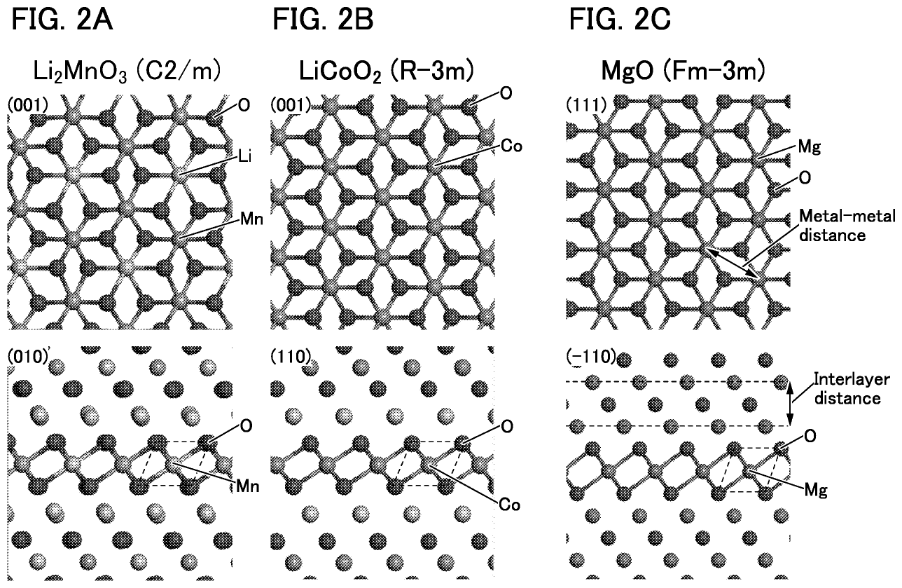

In this embodiment, features of a positive electrode active material particle of one embodiment of the present invention will be described with reference to FIG. 1 and FIGS. 2A to 2C.

A positive electrode active material particle 100 of one embodiment of the present invention contains lithium, a transition metal M, oxygen, and an additive element. The positive electrode active material particle 100 is preferably a compound obtained by adding the additive element to a lithium-rich positive electrode active material particle.

[Lithium-Rich Positive Electrode Active Material Particle]

The lithium-rich positive electrode active material particle refers to a composite oxide having a composition of LiₓM₂₋ₓO₂ (M is one or more selected from Mn, Ni, Co, Cr, Mo, Nb, V, Fe, Ti, and Ru; 1<x<2). Note that 0 may be partly replaced with anions of other elements such as F and/or Cl.

As is clear from the composition represented by LiₓM₂₋ₓO₂(1<x<2), the Li/M(atomic ratio) of the lithium-rich positive electrode active material particle is higher than 1. The Li/M of the positive electrode active material particle 100 of one embodiment of the present invention, which is obtained by adding the additive element to the lithium-rich positive electrode active material particle, is also preferably higher than 1.

Examples of the lithium-rich positive electrode active material particle include a composite oxide having a layered rock-salt crystal structure and a composite oxide having a disordered rock-salt crystal structure.

### <Layered Rock-Salt Crystal Structure>

An example of a lithium-rich positive electrode active material particle having a layered rock-salt crystal structure (also referred to as a lithium-rich layered oxide) is a material synthesized by mixing Li₂MnO₃ and LiMO₂ (M is one or more selected from Mn, Ni, Co, Cr, Mo, Nb, V, Fe, Ti, and Ru) at a certain ratio. Examples of LiMO₂ include LiCoO₂, LiNiO₂, and LiNiₐCo_{b}Mn_{c}O₂ (a+b+c=1). Note that a layered rock-salt crystal structure is referred to as a layered structure in some cases. Similarly, a lithium-rich positive electrode active material particle having a layered rock-salt crystal structure is referred to as a layered lithium-rich positive electrode active material particle, a lithium-rich layered positive electrode active material particle, or the like in some cases.

Li₂MnO₃ has a crystal structure with the symmetry of the space group C2/m, and LiMO₂ has a crystal structure with the symmetry of the space group R-3m. A material synthesized by mixing Li₂MnO₃ and LiMO₂ at a certain ratio is a solid solution having a P2/m crystal structure, a C2/m crystal structure, or an R-3m crystal structure. Alternatively, the material has a composite structure including a region having the C2/m crystal structure and a region having the R-3m crystal structure. The composite structure can include a region having the P2/m crystal structure instead of either of, or in addition to both of, the region having the C2/m crystal structure and the region having the R-3m crystal structure.

Li₂MnO₃ with the space group C2/m and LiMO₂ with the space group R-3m each have a structure in which cations and anions are adjacent to each other and both of them occupy the octahedral sites. Even when the solid solution of these materials has the crystal structure belonging to the space group P2/m, the cations and the anions can both occupy the octahedral sites. These structures, in which octahedrons with anions at the vertices and cations at the centers are edge-shared, can each be regarded as a distorted rock-salt structure. In the case where cations are orderly arranged, composite oxides having the crystal structures belonging to the space groups P2/m, C2/m, and/or R-3m can each have a layered rock-salt crystal structure.

Examples of the lithium-rich positive electrode active material particle having a layered rock-salt crystal structure include Li_{1.14}Mn_{0.46}Ni_{0.2}Co_{0.2}O₂ also represented by 0.3Li₂MnO₃-0.7Li(Ni_{1/3}Co_{1/3}Mn_{1/3})O₂, Li_{1.2}Mn_{0.54}Co_{0.13}Ni_{0.13}O₂ also represented by 0.5Li₂MnO₃-0.5Li(Ni_{1/3}Mn_{1/3}Co_{1/3})O₂, Li_{1.2}Mn_{0.6}Ni_{0.2}O₂ also represented by 0.5Li₂MnO₃-0.5Li(Ni_{1/2}Mn_{1/2})O₂, and Li(Li_{x/3}Mn_{2x/3}Co₁₋ₓ)O₂ (0≤x≤1) also represented by LiCoO₂—Li₂MnO₃.

A lithium-rich positive electrode active material particle having a layered rock-salt crystal structure that contains Mn and Ni as the transition metal M, that has an atomic ratio of Li/transition metals being greater than or equal to 1.3 and less than or equal to 1.7, and that has an atomic ratio of Ni/(Mn+Ni) being greater than or equal to 0.1 and less than or equal to 0.3, such as Li_{1.2}Mn_{0.6}Ni_{0.2}O₂, is particularly preferable because it enables both a high discharge capacity exceeding 200 mAh/g and a relatively high discharge capacity retention rate over cycles.

### <Disordered Rock-Salt Crystal Structure>

A lithium-rich positive electrode active material particle having a disordered rock-salt crystal structure refers to a composite oxide having a composition represented by LiₓM₂₋ₓO₂ (Mis one or more selected from Mn, Ni, Co, Cr, Mo, Nb, V, Fe, Ti, and Ru; 1<x<2), in which a rock-salt crystal structure is included and cations are arranged randomly. Note that 0 may be partly replaced with anions of other elements such as F and/or Cl.

Examples of combinations of elements contained in the lithium-rich positive electrode active material particle having a disordered rock—salt crystal structure include Li—Cr—Mo—O, Li—Ti—Mn—O, Li—Ni—Mn—O, Li—Nb—Mn—O, Li—Nb—Fe—O, Li—Ti—Fe—O, Li—Ti—Ni—O, Li—V—O, Li—Nb—V—O, Li—V—O—F, Li—Mn—O—F, and Li—Mo—O—F.

### [Additive Element]

The positive electrode active material particle 100 preferably contains, as the additive element, one or more selected from magnesium, fluorine, titanium, aluminum, nickel, cobalt, manganese, zirconium, vanadium, iron, chromium, niobium, arsenic, zinc, silicon, sulfur, phosphorus, boron, bromine, and beryllium.

### [Core-Shell Structure]

The positive electrode active material particle 100 includes a core 102 and a shell 101 outside the core 102 as illustrated in FIG. 1.

The core 102 has a feature of the lithium-rich positive electrode active material particle. For example, the core 102 has the same crystal structure and/or composition as the lithium-rich positive electrode active material particle. Thus, the core 102 preferably has a layered rock-salt crystal structure or a disordered rock-salt crystal structure and preferably has any of the above-described compositions.

The shell 101 contains a larger amount of the additive element than the core 102. In other words, the shell 101 has a larger concentration and/or detected amount of the additive element than the core 102. It is preferable that the outer part of the shell 101 have a larger concentration and/or detected amount of the additive element than the inner part.

For example, in XPS analysis, the surface sensitivity is higher in the case where the photoelectron extraction angle is shallow or small than in the case where the photoelectron extraction angle is close to 90°. Thus, when XPS analysis is performed on the positive electrode active material particle 100 with varying photoelectron extraction angles, the concentration and/or detected amount of the additive element are/is preferably larger in the case where the extraction angle is shallow than in the case where the extraction angle is close to 90°.

When magnesium is used as the additive element and the positive electrode active material particle 100 is subjected to XPS analysis at an extraction angle of 45°, the atomic ratio of Mg/M(Mis the sum of one or more selected from Mn, Ni, Co, Cr, Mo, Nb, V, Fe, Ti, and Ru) is preferably higher than or equal to 3%, further preferably higher than or equal to 4%, still further preferably higher than or equal to 5%. When the extraction angle is 15°, the atomic ratio of Mg/M is preferably higher than or equal to 3%, further preferably higher than or equal to 5%, still further preferably higher than or equal to 7%.

When fluorine is used as the additive element and the positive electrode active material particle 100 is subjected to XPS analysis at the extraction angle of 45°, the atomic ratio of F/Mis preferably higher than or equal to 0.15, further preferably higher than or equal to 0.20, still further preferably higher than or equal to 0.30. When the extraction angle is 15°, the atomic ratio of F/M is preferably higher than or equal to 0.15, further preferably higher than or equal to 0.25, still further preferably higher than or equal to 0.35.

Note that when the concentration and/or detected amount of the additive element in the shell 101 are/is too large, lithium diffusion is inhibited, which might result in an increase in internal resistance, decreases in charge and discharge capacities, and the like. Thus, the concentration and/or detected amount of the additive element in the XPS analysis are/is preferably less than or equal to twice the concentration and/or detected amount of lithium, further preferably less than or equal to the concentration and/or detected amount of lithium.

In the case where an element that is not contained in the core 102 is used as the additive element, the element is preferably detected in the shell 101 of the completed positive electrode active material particle 100. In the case where an element that is contained in the core 102 is used as the additive element, it is preferable that the element be detected also in the core 102 of the completed positive electrode active material particle 100 and the concentration and/or detected amount be larger in the shell 101 than in the core 102.

Since the shell 101 contains a larger amount of the additive element than the core 102, the composition of the shell 101 is different from that of the core 102. Thus, the crystal structure of the shell 101 is also preferably different from that of the core 102. For example, the shell 101 preferably has a rock-salt, disordered rock-salt, or spinel crystal structure.

Note that the core 102 and the shell 101 may have the same crystal structure. For example, the core 102 and the shell 101 may differ in constituent elements and/or ratio between the constituent elements but may each have a disordered rock-salt crystal structure.

When the shell 101, which is a region including the surface of the positive electrode active material particle 100 or a region close to the surface thereof, has a rock-salt or spinel crystal structure with a large amount of the additive element, the shell 101 can be expected to exert an effect of inhibiting a side reaction with an electrolyte solution and/or an electrolyte.

When the shell 101 is too thin, the surface and bulk of the positive electrode active material particle 100 cannot be sufficiently stabilized in some cases. Thus, the thickness of the shell 101 is preferably greater than or equal to 1 nm, further preferably greater than or equal to 2 nm, or can be greater than or equal to 3 nm or greater than or equal to 5 nm. Meanwhile, when the shell 101 is thin, high charge and discharge capacities can be easily achieved. This is because the additive element contained in the shell 101 sometimes does not contribute to the oxidation-reduction reaction in the secondary battery. Another reason is that even when the additive element contained in the shell 101 contributes to the oxidation-reduction reaction in the secondary battery, the shell 101 sometimes has a crystal structure which leads to low charge and discharge capacities as compared with a lithium-rich positive electrode active material. Another reason is that the shell 101 which is too thick might cause an increase in electrical resistance and/or lithium ion diffusion resistance. Thus, the thickness of the shell 101 is preferably less than or equal to 10 nm.

### <Substantial Alignment of Orientations>

When the crystal structures of the shell 101 and the core 102 are different from each other, the orientations of the crystal structures of the shell 101 and the core 102 are preferably substantially aligned with each other. When the orientations are substantially aligned with each other, the shell 101 can be stable; thus, oxygen release and cation dissolution from the core 102, for example, can be inhibited more effectively.

In this specification and the like, a state where the orientations of the cubic close-packed structures formed of anions in the rock-salt, layered rock-salt, disordered rock-salt, and spinel crystal structures are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as topotaxy.

The crystal orientations in two regions being substantially aligned with each other can be determined, for example, from a transmission electron microscope (TEM) image, a scanning transmission electron microscope (STEM) image, a HAADF-STEM image, an annular bright-field scanning transmission electron microscope (ABF-STEM) image, an electron diffraction pattern, or the like. It can be determined also from an FFT pattern of a TEM image or an FFT pattern of a STEM image or the like. Furthermore, X-ray diffraction (XRD), neutron diffraction, or the like can also be used for determination.

In a TEM image, a STEM image, or the like, an image reflecting a crystal structure is obtained. An electron diffraction pattern can provide information on crystal orientation in each position. In particular, nanobeam electron diffraction can effectively provide information on crystal orientation in a narrow region.

In the case where the crystal planes of the rock-salt and layered rock-salt crystal structures are aligned with each other, the alignment of the crystal planes can be observed with a high-resolution STEM image, an electron diffraction pattern, or the like. Note that a proper electron diffraction technique such as selected-area diffraction or nanobeam diffraction is preferably used depending on the particle size and/or the range of the rock-salt crystal structure of the shell 101.

In a HAADF-STEM image, for example, a contrast corresponding to the atomic number is obtained, and an element having a larger atomic number can be observed to be brighter. For example, in the case of LiₓM₂₋ₓO₂ (M is one or more selected from Mn, Ni, Co, Cr, Mo, Nb, V, Fe, Ti, and Ru; 1<x<2), the transition metal M has the largest atomic number; hence, an electron beam is strongly scattered at the position of the transition metal M, and arrangement of the transition metal M can be observed as arrangement of high-luminance dots.

When an electron beam is incident perpendicularly to the c-axis of a composite hexagonal lattice of a layered rock-salt crystal structure, arrangement of high-luminance dots derived from the transition metal Mon the (001) plane is obtained as bright bands (bright strips) in a HAADF-STEM image. When an electron beam is incident perpendicularly to the (111) plane of a rock-salt crystal structure, arrangement of dots derived from a metal element on the (111) plane is obtained as bright bands. In the case where repetition of such bright bands is observed in both of the two regions in a STEM image and the angle between the bright bands is 5° or less or 2.5° or less or the difference in distance between the plurality of bright bands is 15% or less, it can be determined that the crystal planes are substantially aligned with each other, that is, the crystal orientations are substantially aligned with each other.

Consequently, in the case where arrangements of high-luminance dots, i.e., bright bands, are observed in two regions having different crystal structures in a HAADF-STEM image and the angle between the arrangements is 5° or less or 2.5° or less or the difference in distance between the arrangements is 15% or less, it can be determined that the crystal orientations are substantially aligned with each other.

In an ABF-STEM image, an element having a smaller atomic number can be observed to be brighter, but a contrast corresponding to the atomic number is obtained as in a HAADF-STEM image; hence, in an ABF-STEM image, crystal orientations can be determined as in a HAADF-STEM image.

An FFT pattern of a TEM image, an FFT pattern of a STEM image or the like, or an electron diffraction pattern can provide information on crystal orientation in each region, e.g., information on whether the [001] direction in a region of the layered rock-salt crystal structure belonging to the space group C2/m or R-3m is substantially aligned with the <111> direction in a region of the rock-salt crystal structure belonging to the space group Fm-3m. In the case where crystal orientations are aligned with a difference of 5° or less or 2.5° or less, it can be determined that the crystal planes are substantially aligned with each other, i.e., the crystal orientations are substantially aligned with each other.

In that case, it is preferable that reciprocal lattice points of the above pattern be spot-shaped, that is, they not be in the shape of concentric rings by being connected to each other. The state where reciprocal lattice points are spot-shaped and not connected to each other means high crystallinity.

Similarly, when the orientations of the rock-salt crystal structure and the disordered rock-salt crystal structure are substantially aligned with each other, the <111> directions of the rock-salt crystal structure and the disordered rock-salt crystal structure may be substantially aligned with each other in some cases. When the orientations of the disordered rock-salt crystal structure and the spinel crystal structure are substantially aligned with each other, the <111> directions of the disordered rock-salt crystal structure and the spinel crystal structure may be substantially aligned with each other in some cases. When the orientations of the layered rock-salt crystal structure and the spinel crystal structure are substantially aligned with each other, the <111> directions of the layered rock-salt crystal structure and the spinel crystal structure may be substantially aligned with each other in some cases.

It is known that in a positive electrode active material particle having a layered rock-salt crystal structure belonging to the space group R-3m, the (001) plane and a plane equivalent thereto and the (104) plane and a plane equivalent thereto are likely to be crystal planes. Thus, to observe the (001) plane with a TEM or the like, for example, a positive electrode active material particle in which a crystal plane that is presumably the (001) plane can be observed with a SEM or the like is preferably selected first; then, the positive electrode active material particle is preferably processed to be thin using a focused ion beam (FIB) or the like such that the (001) plane can be observed with the TEM or the like with an electron beam thereof at [120] incidence. To determine alignment of crystal orientations, a sample is preferably processed to be thin so that the (001) plane of the layered rock-salt crystal structure is easily observed. Similarly, in the case of a positive electrode active material particle having another crystal structure, a sample is preferably processed to be thin so that the arrangement of the transition metal M is easily observed.

When the crystal structure of the shell 101 is substantially the same as that of the core 102, the shell 101 containing a large amount of the additive element functions as a pillar that supports the crystal structure of the positive electrode active material particle 100. As the additive element, magnesium is particularly preferable because it has a strong bond with oxygen and thus can be expected to be highly functional as the pillar for the positive electrode active material particle 100. That is, the presence of the additive element stabilizes the crystal structure of the surface and/or bulk of the positive electrode active material particle 100. This can inhibit the positive electrode active material particle 100 from having a change in crystal structure and/or releasing oxygen during charging.

Accordingly, the positive electrode active material particle 100 can inhibit a decrease in initial discharge capacity with respect to initial charge capacity, can improve rate performance, or can inhibit a decrease in voltage or discharge capacity during charge and discharge cycles.

### <Example of Substantial Alignment of Orientations>

To have different crystal structures and substantially aligned orientations, the shell 101 and the core 102 need to have no significant mismatch in lattice constant between the two in addition to a common anion packing structure. To be more precise in consideration of the case of different space groups and the like, the shell 101 and the core 102 need to have no significant mismatches in metal-metal distance and interlayer distance. The metal-metal distance refers to the average distance between the nearest neighbor metal atoms in the same layer. The interlayer distance refers to the average distance between two metal layers. The metal layer refers to a plane where metal atoms are arranged, and refers to the (111) plane in the case of the rock-salt structure or the disordered rock-salt structure (Fm-3m). In the case of the layered rock-salt structure (R-3m, C/2m, or P2/m), the metal layer refers to the (001) plane. In the case of the spinel structure (Fd-3m), the metal layer refers to the (111) plane. In the case where there are a plurality of kinds of metals with regularity, a plane where the largest number of metals of the same kind are arranged is referred to as the metal layer in some cases.

The core 102 and the shell 101 can have substantially the same crystal structure when the relative value of the metal-metal distance or the interlayer distance of the core 102 to that of the shell 101 is greater than or equal to 0.94 and less than or equal to 1.06.

Examples in which the shell 101 and the core 102 have different crystal structures and substantially aligned crystal orientations are described below.

Described first is an example in which the core 102 has the layered rock-salt crystal structure and composition of the lithium-rich positive electrode active material particle and the shell 101 has the rock-salt crystal structure.

The lithium-rich positive electrode active material particle having a layered rock-salt crystal structure is a material synthesized by mixing Li₂MnO₃ and LiMO₂ (M is one or more selected from Mn, Ni, Co, Cr, Mo, Nb, V, Fe, Ti, and Ru) at a certain ratio. Thus, the metal-metal distance and the interlayer distance of the core 102 each probably have a value between the values of Li₂MnO₃ and LiMO₂. Table 1 shows the known experimental values of the metal-metal distance and the interlayer distance of Li₂MnO₃. Table 1 also shows the known experimental values of LiCoO₂, LiNiO₂, LiNi_{1/2}Mn_{1/2}O₂, and LiNi_{1/3}Mn_{1/3}Co_{1/3}O₂, which are examples of LiMO₂. Each value has four significant figures. Their interlayer distances are greater than or equal to 2.342 Å and less than or equal to 2.382 Å, and their metal-metal distances are greater than or equal to 2.816 Å and less than or equal to 2.887 Å.

TABLE 1

| | | ICSD | Interlayer distance | | Metal-metal distance | |
|---|---|---|---|---|---|---|
| | Space | Collection | Experimental | Relative | Experimental | Relative |
| Crystal structure | group | Code | value (Å) | value | value (Å) | value |
| Li₂MnO₃ | C2/m | 73370 | 2.369 | 0.97 | 2.842 | 0.95 |
| LiCoO₂ | R-3m | 51182 | 2.342 | 0.96 | 2.816 | 0.94 |
| MgO | Fm-3m | 9863 | 2.435 | 1.00 | 2.982 | 1.00 |
| LiNi_{1/3}Mn_{1/3}Co_{1/3}O₂ | R-3m | 34304 | 2.377 | 0.98 | 2.867 | 0.96 |
| LiNi_{1/2}Mn_{1/2}O₂ | R-3m | 152273 | 2.382 | 0.98 | 2.887 | 0.97 |
| LiNiO₂ | R-3m | 78687 | 2.367 | 0.97 | 2.883 | 0.97 |
| CoO | Fm-3m | 9865 | 2.461 | 1.01 | 3.014 | 1.01 |
| NiO | Fm-3m | 9866 | 2.412 | 0.99 | 2.954 | 0.99 |
| MnO | Fm-3m | 9864 | 2.567 | 1.05 | 3.144 | 1.05 |

The upper part of FIG. 2A is a schematic diagram of the (001) plane of the crystal structure of Li₂MnO₃ belonging to the space group C2/m, and the lower part of FIG. 2A is a schematic diagram of the (010) plane perpendicular to the (001) plane. The (001) plane of the crystal structure of Li₂MnO₃ is a plane where metals are arranged in a layer. For clarity of the drawing, the upper part of FIG. 2A selectively illustrates the (001) plane with one metal layer and upper and lower oxygen layers. The lower part of FIG. 2A illustrates the (010) plane with bonding of only one metal layer and upper and lower oxygen layers.

Note that the crystal structure of Li₂MnO₃ (ICSD Collection Code: 73370) includes a mixed layer of Li and Mn and a layer of Li alone as metal layers. These layers are parallel or substantially parallel to the a-axis and the b-axis. In addition, Li and Mn partially occupy the metal sites in the mixed layer of Li and Mn. However, for simplicity of the drawing, FIG. 2A illustrates either one of the elements which has a higher occupancy rate in the mixed layer of Li and Mn. Since the metal sites in Li₂MnO₃ are deviated from the regular triangle arrangement, the metal-metal distance in Li₂MnO₃ can be obtained by the following two methods.

One method is to obtain the metal-metal distance from the average distance between metal atoms in the mixed layer of Li and Mn. Note that the layer of Li alone is not used for calculation because the positions of the atoms are slightly deviated from the same plane. The metal-metal distance obtained by this method is 2.842 Å, with four significant figures.

The other method is to calculate x as the metal-metal distance assuming that the length of the a-axis (4.921 Å) is (√3)x, the length of the b-axis (8.526 Å) is 3x, and the product of the length of the a-axis and the length of the b-axis (41.95645 Å²) is 3(√3)x². The metal-metal distance obtained by this method is 2.842 Å, with four significant figures. The metal-metal distances obtained by the two methods have the same four significant figures.

The upper part of FIG. 2B is a schematic diagram of the (001) plane of the crystal structure of LiCoO₂ belonging to the space group R-3m as an example of LiMO₂, and the lower part of FIG. 2B is a schematic diagram of the (110) plane perpendicular to the (001) plane. The (001) plane of the crystal structure of LiCoO₂ is a plane where metals are arranged in a layer. For clarity of the drawing, the upper part of FIG. 2B selectively illustrates the (001) plane with one metal layer and upper and lower oxygen layers. The lower part of FIG. 2B illustrates the (110) plane with bonding of only one metal layer and upper and lower oxygen layers.

The shell 101 has a larger concentration and/or detected amount of the additive element than the core 102. Thus, the metal-metal distance and the interlayer distance of the shell 101 each probably have a value between the values of a rock-salt oxide of the additive element and the crystal structure of the core 102. Here, magnesium, cobalt, nickel, and manganese are given as examples of the additive element, and Table 1 shows the known experimental values of the metal-metal distances and the interlayer distances of MgO, CoO, NiO, and MnO. Each of the values of the metal-metal distances and the interlayer distances of the rock-salt oxides has four significant figures. Their interlayer distances are greater than or equal to 2.412 Å and less than or equal to 2.567 Å, and their metal-metal distances are greater than or equal to 2.954 Å and less than or equal to 3.144 Å.

The upper part of FIG. 2C is a schematic diagram of the (111) plane of the crystal structure of MgO belonging to the space group Fm-3m as an example of the rock-salt oxide of the additive element, and the lower part of FIG. 2C is a schematic diagram of the (−110) plane perpendicular to the (111) plane. The (111) plane of the crystal structure of MgO is a plane where metals are arranged in a layer. For clarity of the drawing, the upper part of FIG. 2C selectively illustrates the (111) plane with one metal layer and upper and lower oxygen layers. The lower part of FIG. 2C illustrates the (−110) plane with bonding of only one metal layer and upper and lower oxygen layers.

As illustrated in FIGS. 2A to 2C, these oxides have different space groups but are the same in that oxygens form a cubic close-packed structure and cations and anions are alternately arranged. As indicated by dotted lines in FIGS. 2A to 2C, each cation is present at the six-coordinated octahedral site.

Table 1 shows the relative values of the distances assuming that the metal-metal distance and the interlayer distance of MgO are each 1. Note that the interlayer distances of Li₂MnO₃ and LiCoO₂ depend on the positions of layers; thus, the average values are shown in Table 1.

The relative values of the metal-metal distances and the interlayer distances assuming that the metal-metal distance and the interlayer distance of MgO are each 1 are greater than or equal to 0.94 and less than or equal to 1.06, and it is clear that these crystal structures have no significant mismatch. Thus, the shell 101 and the core 102 can have substantially the same crystal structure in the case where the core 102 has the composition and layered rock-salt crystal structure of the lithium-rich positive electrode active material particle given above as an example and the shell 101 contains magnesium, cobalt, nickel, and/or manganese as the additive element(s) and has the rock-salt crystal structure.

Described next is an example in which the core 102 has the disordered rock-salt crystal structure and composition of the lithium-rich positive electrode active material particle and the shell 101 has the rock-salt crystal structure. Since the disordered rock-salt crystal structure of the core 102 is the same as the rock-salt crystal structure of the shell 101, these crystal structures can be compared using lattice constants.

Non-Patent Document 5 discloses that Li_{1.05}Mn_{0.85}Ti_{0.1}O₂, Li_{1.10}Mn_{0.70}Ti_{0.2}O₂, and Li_{1.15}Mn_{0.55}Ti_{0.3}O₂, which are lithium-rich positive electrode active materials having the disordered rock-salt crystal structure, have lattice constants a of 4.16 Å to 4.17 Å.

Here, magnesium is given as an example of the additive element. The lattice constant a of MgO is 4.217 Å.

Accordingly, the relative value of the lattice constant a of the lithium-rich positive electrode active material particle having the disordered rock-salt crystal structure to the lattice constant a of MgO is greater than or equal to 0.986 and less than or equal to 0.989, and it is clear that these crystal structures have no significant mismatch.

Thus, the shell 101 and the core 102 can have substantially the same crystal orientation in the case where the core 102 has the composition and disordered rock-salt crystal structure of the lithium-rich positive electrode active material particle given above as an example and the shell 101 contains magnesium as the additive element and has the rock-salt crystal structure.

Described next is an example in which the core 102 or the shell 101 has the spinel crystal structure. In the case of evaluating substantial alignment of crystal orientations between the spinel crystal structure and another crystal structure, it is preferable to compare their oxygen stackings and the relative values of their interlayer distances between oxygen layers.

An example of a spinel crystal structure containing Li and Mn (space group: Fd-3m) is a crystal structure of LiMn₂O₄(ICSD Collection Code: 73370). Oxygen stacking in the spinel crystal structure forms a cubic close-packed structure with ABCABC . . . stacking along the <111> direction.

Oxygens in the rock-salt crystal structure also form a cubic close-packed structure with ABCABC . . . stacking along the <111> direction. Oxygen layers in the layered rock-salt crystal structure belonging to R-3m also form a cubic close-packed structure with ABCABC . . . stacking along the [001] direction. Oxygen layers in the layered rock-salt crystal structure belonging to C/2m also form a cubic close-packed structure with ABCABC . . . stacking along a direction substantially perpendicular to the c-plane.

Thus, when the interlayer distance of the oxygen layer stacking matches with the oxygen-oxygen distance in LiMn₂O₄ having the spinel crystal structure, the crystal orientation of the spinel crystal structure is substantially aligned with those of the rock-salt structure (Fm-3m) and the layered rock-salt structure (R-3m, C/2m).

Note that in the rock-salt crystal structure belonging to the space group Fm-3m, the metal-metal distance is equal to the oxygen-oxygen distance. Similarly, the interlayer distance between metal layers is equal to the interlayer distance between oxygen layers. Also in the layered rock-salt crystal structure of LiCoO₂ or the like belonging to the space group R-3m, the metal-metal distance is equal to the oxygen-oxygen distance. In the layered rock-salt crystal structure of LiCoO₂ or the like, oxygens and metals are alternately arranged, and the average interlayer distance between metal layers is equal to the average interlayer distance between oxygen layers. In Li₂MnO₃, oxygens and metals are alternately arranged in a direction perpendicular to the (001) plane, and the average interlayer distance between metal layers is equal to the average interlayer distance between oxygen layers. The latter of the above-described methods for obtaining the metal-metal distance can be applied to the case of obtaining the oxygen-oxygen distance in the layered rock-salt crystal structure belonging to the space group C/2m. In other words, the oxygen-oxygen distance on the same plane is equal to the metal-metal distance obtained earlier. Thus, the metal-metal distance shown in Table 1 can be regarded as equal to the oxygen-oxygen distance. Similarly, the interlayer distance between metal layers shown in Table 1 can be regarded as equal to the interlayer distance between oxygen layers.

The positions of oxygens on the (111) plane of LiMn₂O₄ are deviated from the positions of the triangle lattice points. Thus, it is assumed here that oxygens are positioned at the triangle lattice points present on the same plane and the distance between the triangle lattice points corresponds to the oxygen-oxygen distance. The oxygen-oxygen distance calculated under this assumption is 2.908 Å, and its relative value to the oxygen-oxygen distance of MgO is 0.98.

Since the positions of oxygens in LiMn₂O₄ are deviated with respect to the (111) plane, the average position of oxygen on the (111) plane is assumed to be the position of oxygen on the (111) plane, and the distance between oxygen layers in the [111] direction obtained using the position of oxygen on the (111) plane is assumed to be the interlayer distance between oxygen layers. The interlayer distance between oxygen layers calculated under this assumption is 2.375 Å, and its relative value to the interlayer distance between oxygen layers of MgO is 0.98. As described above, the relative values of the oxygen-oxygen distance and the interlayer distance between oxygen layers of LiMn₂O₄ to those of MgO are each greater than or equal to 0.94 and less than or equal to 1.06.

Thus, in the case where the core 102 has the spinel crystal structure like LiMn₂O₄, the crystal orientation of the core 102 can be substantially aligned with that of the shell 101 having the rock-salt crystal structure containing Mg. In the case where the shell 101 has the spinel crystal structure like LiMn₂O₄, the crystal orientation of the shell 101 can be substantially aligned with that of the core 102 having the layered rock-salt crystal structure and/or the disordered rock-salt crystal structure.

The diameter of the positive electrode active material particle 100 is preferably less than or equal to 500 nm, further preferably less than or equal to 250 nm, still further preferably approximately 100 nm in order to reduce lithium diffusion resistance in the particle. However, an excessively small particle diameter might cause a disadvantage such as easy cohesion. Thus, the diameter is preferably greater than or equal to 25 nm, further preferably greater than or equal to 50 nm.

Although the features of a primary particle of the positive electrode active material particle 100 are described in this specification and the like unless otherwise specified, the positive electrode active material particle may include a secondary particle in which a plurality of primary particles are cohered, fixed, and/or sintered. The secondary particle is preferably included, in which case the particle diameter is increased and application to a current collector or the like is facilitated.

When the positive electrode active material particle 100 includes a secondary particle, the shell 101 may be formed in each primary particle included in the secondary particle. Alternatively, the shell 101 may be formed in the secondary particle as one particle. In other words, the secondary particle may include a primary particle that does not include the shell 101. An additive element may be used as a sintering additive in the formation of the secondary particle from primary particles.

Note that the shell 101 preferably has the rock-salt crystal structure or the spinel crystal structure, but the shell 101 alone does not necessarily have the rock-salt crystal structure or the spinel crystal structure. For example, part of the core 102 may have the rock-salt crystal structure or the spinel crystal structure.

The shell 101 does not necessarily cover the entire surface of the positive electrode active material particle 100. To function as a pillar, however, the shell 101 preferably exists as 50% or more, preferably 70% or more, further preferably 90% or more of the surface of the positive electrode active material particle 100.

The shell 101 does not necessarily have the rock-salt crystal structure or the spinel crystal structure entirely. For example, part of the shell 101 may be amorphous or may have another crystal structure. Similarly, the core 102 does not necessarily have the layered rock-salt crystal structure or the disordered rock-salt crystal structure entirely. For example, part of the core 102 may be amorphous or may have another crystal structure.

### [Analysis]

### <Composition>

The composition of the positive electrode active material particle 100 of one embodiment of the present invention is preferably evaluated by a combination of a plurality of analyses. For example, the proportions of lithium, the transition metal M, and oxygen, which are main constituent elements of the positive electrode active material particle 100, are preferably obtained by inductively coupled plasma mass spectrometry (ICP-MS) or the like. The proportion of the additive element is preferably obtained by an analysis with high sensitivity to an element in a trace amount, such as glow discharge mass spectrometry (GD-MS).

### <Distribution of Additive Element>

The distribution of the additive element in the positive electrode active material particle 100 of one embodiment of the present invention is preferably evaluated by cross-sectional analysis of the positive electrode active material particle 100, for example.

For example, cross-sectional STEM-EDX is preferable because of its high spatial resolution. To increase the spatial resolution in STEM-EDX line analysis, the diameter of an electron beam (also referred to as a beam diameter, a probe size, or a probe diameter) is preferably small. The beam diameter in STEM-EDX line analysis is preferably less than or equal to 0.3 nm, further preferably less than or equal to 0.2 nm, still further preferably less than or equal to 0.1 nm.

A cross-sectional electron probe microanalyzer (EPMA) is preferable because of its low element detection limit.

A plurality of analyses can be combined for evaluation as needed.

The interface between the shell 101 and the core 102 is defined by a series of points each having a value closest to half of the sum of the detected amount of the additive element in a center portion of the positive electrode active material particle 100 and the maximum detected amount of the additive element in a portion in the vicinity of the surface of the positive electrode active material particle 100. In the case where a plurality of additive elements are contained, the element that is the easiest to detect and/or quantify is used in consideration of the composition of the positive electrode active material particle 100. For example, any additive element that is not contained in the core 102 is preferably used. It is also preferable to use an element whose characteristic X-ray spectrum has a small overlap with that of an element contained in the core 102. Furthermore, it is preferable to use an element detected in a larger amount in the vicinity of the surface.

### <Surface>

Since the positive electrode active material particle of one embodiment of the present invention is a compound containing oxygen and a transition metal Minto and from which lithium can be inserted and extracted, an interface between a region where oxygen and the transition metal M that is oxidized or reduced due to insertion and extraction of lithium are present and a region where oxygen and the transition metal M are absent is considered as the surface of the positive electrode active material particle in this specification and the like. A plane generated by slipping and/or a crack also can be considered as the surface of the positive electrode active material particle. When the positive electrode active material particle is analyzed, a protective film is attached on its surface in some cases; however, the protective film is not included in the positive electrode active material particle. As the protective film, a single-layer film or a multilayer film of carbon, a metal, an oxide, a resin, or the like is sometimes used.

For a similar reason, the positive electrode active material particle of one embodiment of the present invention does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material particle. The attached metal oxide refers to, for example, a metal oxide having a crystal structure substantially different from that of a lithium-rich positive electrode active material particle.

Furthermore, an electrolyte, an organic solvent, a binder, a conductive material, and a compound originating from any of these that are attached to the positive electrode active material particle are not contained in the positive electrode active material particle either.

In STEM-EDX line analysis or the like, it is sometimes difficult to precisely determine the surface because a steep change in the detected amount of the characteristic X-ray of an element is not seen in principle or due to a measurement error. Accordingly, when STEM-EDX line analysis or the like in the depth direction is described, the reference point is a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal Min the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal Min the inner portion and the average value M_{BG} of the detected amounts of the characteristic X-ray of the transition metal M of the background can be employed as the reference point. In the case of the positive electrode active material particle 100 containing a plurality of the transition metals M, the reference point can be determined using M_{AVE} and M_{BG} of the transition metal element whose detected amount of the characteristic X-ray in the inner portion is larger than that of any other element.

The average value M_{BG} of the detected amounts of the characteristic X-ray of the transition metal M of the background can be calculated by averaging the amount in the range greater than or equal to 2 nm, preferably greater than or equal to 3 nm, which is outside the positive electrode active material particle 100 and excludes the neighborhood of the portion at which the detected amount of the characteristic X-ray of the transition metal M begins to increase, for example. The average value M_{AVE} of the detected amounts of the characteristic X-ray of the transition metal Min the inner portion can be calculated by averaging the detected amounts in the range greater than or equal to 2 nm, preferably greater than or equal to 3 nm, further preferably greater than or equal to 10 nm at the depth at which the detected amounts of the characteristic X-ray of the transition metal M and oxygen are saturated and stabilized, e.g., at a depth larger than, by greater than or equal to 30 nm, preferably greater than 50 nm, the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material particle in, for example, a cross-sectional scanning transmission electron microscope (STEM) image is a boundary between a region where an image derived from the crystal structure of the positive electrode active material particle can be observed and a region where the image is not observed. The surface of the positive electrode active material particle is also determined as the outermost surface of a region where an atomic column derived from an atomic nucleus of, among constituent metal elements of the positive electrode active material particle, a metal element that has a larger atomic number than lithium can be observed in the cross-sectional STEM image. The surface in a STEM image or the like may be determined by using additionally an analysis with higher spatial resolution.

STEM observation and STEM-EDX line analysis are performed on a thin sample. The thin sample is formed by performing thinning after forming a protective film on a surface of a positive electrode active material.

Carbon can be used for the protective film. A carbon film can be formed by evaporation of carbon using a carbon coating unit of an ion sputtering apparatus. Alternatively, carbon can be deposited using FIB. A carbon film formed using FIB has a smaller amount of oxygen entry and is thus more suitable for analysis of an oxide.

The thinning can be performed with an FIB-SEM apparatus (NX5200, produced by Hitachi High-Tech Corporation), for example. In that case, it is preferable that the sample be picked up by a micro probing system (MPS) and that the acceleration voltage be gradually decreased from a high-acceleration voltage to a low-acceleration voltage in the order of 30 kV, 10 kV, and 5 kV (and 2 kV), for example, so that the processing can be completed while a layer damaged by the processing is removed. It is also preferable to measure a portion of the thinned sample with a small depth and little unevenness.

In EDX measurement of a surface portion of the positive electrode active material particle, the magnification is preferably set such that sufficient information on a region to several nanometers from the surface can be obtained. For example, the magnification is preferably set such that the electron beam scanning pitch in EDX area analysis is approximately 0.3 nm or the measurement magnification is approximately 160000 times (or twice, i.e., 320000 times, on the display screen because of drift correction).

In STEM-EDX analysis, elements can be quantified by a standardless quantification method using k-factors, which are element-specific coefficients, stored in an analysis apparatus and/or analysis software. Target elements (also referred to as denominator elements) for obtaining the element concentrations from the quantification results preferably include elements used for a target material, a raw material, a mesh on which a thin sample is placed, and an apparatus member and an element used for thinning. For example, the target elements are preferably 15 elements of C, O, F, Mg, Al, Si, P, S, Ca, Ti, Mn, Fe, Co, Ni, and Ga. The net counts, which represent the total number of detection counts, and the concentration can be optionally output. The simple term “detected amount” of an element includes the characteristic X-ray counts and the concentration. The term “concentration” includes the weight % (wt %) and the atomic % (at %).

The spatial resolution of STEM-EDX depends on the probe size. Thus, the maximum value of an additive element profile may be shifted by approximately 1 nm depending on conditions such as the probe size. For example, even when the maximum value of the profile of an additive element such as magnesium is outside the surface determined in the above-described manner, it can be said that a difference between the maximum value and the surface is within the margin of error as long as the difference is less than 1 nm.

A peak in STEM-EDX line analysis refers to the local maximum value of a projecting shape appearing in the graph of the detected amount of the characteristic X-ray of each element or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions or increasing the number of frames.

<Particle Size Distribution Analysis with Cross-Sectional SEM Image of Positive Electrode>

The particle size distribution of the positive electrode active material particle 100 can be calculated from the cross-sectional SEM image of the positive electrode active material particle 100 by the following method, for example.

First, an analysis region is cut out from the obtained cross-sectional SEM image to obtain a cross section of the positive electrode active material particle 100 that is sufficient for image analysis. For example, it is preferable to cut out an area where 100 or more cross sections of the positive electrode active material particle 100 can be obtained.

Note that a function of image processing software may be used to cut out the analysis region from the cross-sectional SEM image. For example, ImageJ may be used as image processing software and the analysis region may be cut out by Crop function of ImageJ.

Next, a first image cut out by the image processing software is binarized and subjected to particle analysis.

ImageJ can be used as the image processing software, for example. The binarization process is described below. The first image represented by a 256-level grayscale is used as a frequency graph excluding black (a value of 0) and white (a value of 255). As the half width at half maximum (HWHM) of the maximum peak in the frequency graph, HWHM on the low-level side (HWHM_L) and HWHM on the high-level side (HWHM_H) are obtained. Next, the minimum value a in a range that is twice HWHM_L on the low-level side and the maximum value b in a range that is twice HWHM_H on the high-level side are determined from the peak top (maximum frequency) of the maximum peak.

Next, binarization processing is performed as follows: the range of values less than a is white, the range of values from a to b, inclusive, is black, and the range of values greater than b is white. Specifically, the binarization as Threshold (a, b) is performed with Threshold function of ImageJ. After that, random bright spots that are probably attributed to the conductive material are removed under the conditions of Gray Morphology (radius=3, operator=open, type=circle) and Gray Morphology (radius=1, operator=close, type=circle), so that a second image can be obtained.

Next, particles with a particle size (projected area) of 0.5 μm² to 700 μm² are detected in the second image with Analyze Particles function of ImageJ, whereby the area S of each particle is obtained. Next, the diameter r of each particle is calculated on the basis of the area S of each particle (Formula 1).

$$\begin{matrix}[ Formula 1 ] & \\ r = 2 \times \sqrt{( S / π )} & ( 1 )\end{matrix}$$

In this manner, the particle size distributions can each be calculated from the cross-sectional SEM image. The above analysis is referred to as particle size distribution analysis using a cross-sectional SEM image of a positive electrode.

This embodiment can be combined with the content of any of the other embodiments as appropriate.

### Embodiment 2

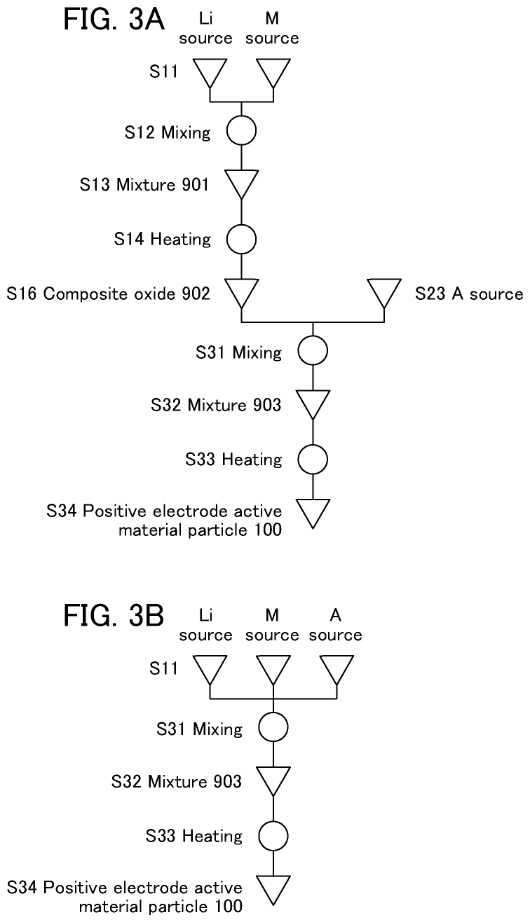

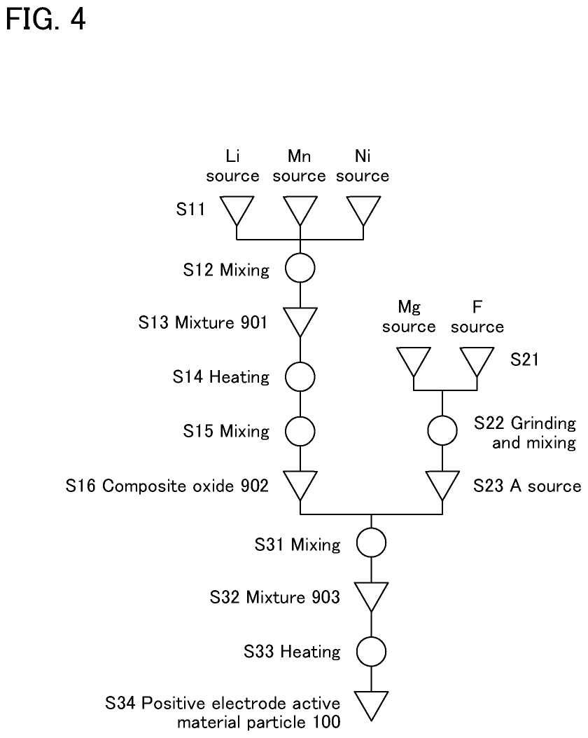

In this embodiment, examples of methods for forming the positive electrode active material particles of one embodiment of the present invention will be described with reference to FIGS. 3A and 3B and FIG. 4.

### [Formation Method 1]

First, an example of a method for synthesizing LiₓM₂₋ₓO₂ (M is one or more selected from Mn, Ni, Co, Cr, Mo, Nb, V, Fe, Ti, and Ru; 1<x<2) and then adding an additive element source is described with reference to FIG. 3A. Although there is no particular limitation on the method for synthesizing LiₓM₂₋ₓO₂, an example of employing a solid phase method is described in this embodiment.

First, in Step S11 in FIG. 3A, a lithium (Li) source and an M source are prepared. As the lithium source, for example, lithium carbonate (Li₂CO₃), lithium hydroxide (LiOH), and/or lithium oxide (Li₂O) can be used. As the M source, an oxide, a hydroxide, or a carbonate of the transition metal Mor the like can be used. For example, manganese oxide (Mn₂O₃, MnO₂, and/or MnO), manganese carbonate (MnCO₃), nickel oxide (NiO₂), nickel carbonate (NiCO₃), nickel hydroxide (Ni(OH)₂), cobalt oxide (CO₂O₃), cobalt hydroxide (Co(OH)₂), chromium oxide (Cr₂O₃), molybdenum dioxide (MoO₂), niobium oxide (NbO or Nb₂O₅), vanadium oxide (V₂O₃), iron oxide (Fe₂O₃), titanium oxide (TiO₂), ruthenium oxide (RuO₂), or the like can be used.

Next, in Step S12, the lithium source and the M source are mixed to form a first mixture 901 (Step S13). Grinding in the mixing step is effective in reducing the particle size. A bead mill and/or a ball mill are/is preferably used for grinding. A planetary ball mill can be used as the ball mill. Either a dry method or a wet method may be used for the bead mill and/or the ball mill. In the case where heat is generated during mixing and grinding, the mixing and grinding are preferably performed while cooling is performed.

Next, in Step S14, the first mixture 901 formed in the preceding step is heated. When the heating temperature is high, the heating time can be shortened and thus the productivity can be improved. However, when the heating temperature is too high, the particle size might be increased by sintering of particles or the like and thus the charge and discharge capacities might be decreased. In addition, the transition metal is likely to be reduced, and for example, Mn might be reduced from a tetravalent state to a trivalent state, which might lead to a failure in synthesis of a composite oxide with an intended composition. The heating time is preferably short because the productivity can be improved; however, when the heating time is too short, the reaction might be insufficient. Thus, the heating temperature is preferably higher than or equal to 700° C. and lower than or equal to 1200° C., further preferably higher than or equal to 800° C. and lower than or equal to 1050° C., still further preferably higher than or equal to 850° C. and lower than or equal to 950° C., for example. The heating time is preferably longer than or equal to 15 minutes and shorter than or equal to 100 hours, further preferably longer than or equal to 2 hours and shorter than or equal to 20 hours, for example. In the case where heating is performed a plurality of times, the conditions need to be set such that appropriate synthesis is performed in the whole formation process. Since this formation method includes two heating steps in Step S14 and Step S33, the heating temperature and/or the heating time in each step are/is preferably lower and/or shorter in this formation method than in a formation method where heating is performed only once. For example, the heating temperature in Step S14 is further preferably lower than or equal to 950° C.

With the above-described heating conditions, LiₓM₂₋ₓO₂ which is inhibited from having an increase in particle size can be formed. Note that the heating time here is the time in which the heating temperature is maintained, and does not include the temperature rising time and the temperature dropping time.

As a heating furnace, a muffle furnace, a roller hearth kiln, a rotary kiln, or the like can be used, for example. As a container holding an object to be heated, a crucible made of aluminum oxide or a setter (also referred to as a saggar) made of aluminum oxide can be used. The crucible or the setter is preferably covered with a lid before heating, in which case evaporation of a material can be prevented. Furthermore, as a material of the crucible and the setter, mullite-cordierite may be used.

In the case of forming LiₓM₂₋ₓO₂ having a layered rock-salt crystal structure, heating is preferably performed in an oxygen-containing atmosphere. In the case of forming LiₓM₂₋ₓO₂ having a disordered rock-salt crystal structure, heating is preferably performed in an inert atmosphere such as an argon or nitrogen atmosphere.

When the amount of the first mixture 901 in each heating container is too large in this heating step, the first mixture 901 cannot be sufficiently in contact with the atmosphere, which might result in a partially insufficient reaction. Thus, it is preferable that heating be performed separately using a plurality of heating containers as needed. In the case where heating is performed separately using a plurality of heating containers, mixing is performed after the heating. A bead mill, a ball mill, a mortar, a mix rotor, and/or a mixer can be used for the mixing.

Through the above steps, a composite oxide 902 represented by LiₓM₂₋ₓO₂ is obtained (Step S16).

Next, an additive element (A) source is prepared in Step S23. In this specification and the like, an additive element can be rephrased as part of a raw material or a mixture. As the additive element source, a single additive element can be used, or a compound of the additive element can be used.

In the case where magnesium is used as the additive element, magnesium oxide (MgO) and/or magnesium fluoride (MgF₂) can be used as a magnesium source, for example. In the case where fluorine is used as the additive element, a fluorine source is preferably a fluoride of a typical metal element, and lithium fluoride (LiF), sodium fluoride (NaF), potassium fluoride (KF), and/or magnesium fluoride (MgF₂) can be used, for example. In view of the use for lithium-ion secondary batteries, lithium fluoride is particularly preferably used as the fluorine source.

Such a fluoride of a typical metal element functions as a fusing agent in a later heating step and can promote diffusion of the additive element in the shell 101 and doping of the shell 101 with the additive element. A mixture containing a fluoride is preferable because its melting point is sometimes lower than the decomposition temperature of the composite oxide represented by LiₓM₂₋ₓO₂ and its safety is high. A mixture of materials whose eutectic point is 1000° C., preferably lower than or equal to 900° C. in an oxygen-containing atmosphere is particularly suitable because the mixture is likely to be liquid at a relatively low temperature.

After functioning as a fusing agent, the fluoride might lose fluorine through volatilization or the like; thus, even when fluorine is added as the additive element, fluorine is sometimes not detected from the formed positive electrode active material particle 100.

Next, in Step S31, the composite oxide 902 and the additive element source are mixed to form a second mixture 903 (Step S32). For the mixing, the description of Step S12 can be referred to.

Next, in Step S33, the second mixture is heated. An excessively low heating temperature might lead to uneven and/or insufficient doping with the additive element. Thus, the heating temperature is preferably higher than or equal to 500° C., further preferably higher than or equal to 700° C., still further preferably higher than or equal to 850° C. In contrast, an excessively high temperature might lead to thermal decomposition of the composite oxide 902 and a larger particle size than necessary due to sintering of particles, for example. Thus, the heating temperature is preferably lower than or equal to 1050° C. In order to inhibit volatilization of the fluoride such as lithium fluoride, the temperature is further preferably lower than or equal to 950° C. Accordingly, the heating in Step S33 is typically preferably performed at higher than or equal to 850° C. and lower than or equal to 950° C.

The heating time is preferably short because the productivity can be improved; however, when the heating time is too short, diffusion of the additive element and doping with the additive element might be insufficient. The heating time is preferably longer than or equal to 15 minutes and shorter than or equal to 100 hours, further preferably longer than or equal to 2 hours and shorter than or equal to 20 hours, for example.

In the heating step in Step S33, the composite oxide 902 and the additive element source are partially melted to effectively induce diffusion of the additive element such as magnesium and doping with the additive element. Because of the partial melting, the crystal structure of the shell 101 is affected by the crystal structure of the core 102, so that the shell 101 and the core 102 have substantially the same crystal structure. The shell 101 formed in this manner stabilizes the crystal structure of the surface and bulk of the positive electrode active material particle 100. This can effectively inhibit the positive electrode active material particle 100 from having a change in crystal structure and/or releasing oxygen during charging.

Note that the optimal ranges of the heating temperature and the heating time may depend on the particle size of the composite oxide 902.

Through the above steps, the positive electrode active material particle 100 can be formed (Step S34).

### [Formation Method 2]

In the formation method 1, the additive element is added and heating is performed after the composite oxide represented by LiₓM₂₋ₓO₂ is synthesized; however, the method for forming the positive electrode active material particle of one embodiment of the present invention is not limited thereto. The addition of the additive element may be performed at another timing or may be performed a plurality of times. The timing of the addition may be different between the elements. As a formation method 2, an example in which the additive element is added at a timing different from that in the formation method 1 is described with reference to FIG. 3B.

In the formation method 2 illustrated in FIG. 3B, the additive element is added in the 35 step of forming the composite oxide represented by LiₓM₂₋ₓO₂ (M is one or more selected from Mn, Ni, Co, Cr, Mo, Nb, V, Fe, Ti, and Ru; 1<x<2). In other words, in Step S11, the lithium source, the M source, and the additive element source are mixed and heated for synthesis. Also in the case of such a formation process, the shell 101 can contain a large amount of a certain additive element under certain heating conditions. For example, when an additive element with a low solid solubility limit in the composite oxide represented by LiₓM₂₋ₓO₂ is used, the shell 101 containing a large amount of the additive element can be formed.

The formation method 1 and FIG. 3A can be referred to for details other than the timing of adding the additive element.

### [Formation Method 1-1]

Next, a formation method 1-1, which is a more specific example of the formation method 1, is described with reference to FIG. 4. In this formation method, manganese and nickel are used as the transition metal M, and magnesium and fluorine are used as additive elements.

First, in Step S11 in FIG. 4, a lithium (Li) source, a manganese (Mn) source, and a nickel (Ni) source are prepared. As the lithium source, lithium carbonate (Li₂CO₃) can be used, for example. As the manganese source, manganese carbonate (MnCO₃) can be used, for example. As the nickel source, nickel carbonate (NiCO₃) can be used, for example.

Next, in Step S12, the lithium source, the manganese source, and the nickel source are mixed to form a first mixture 901 (Step S13). In this formation method, the mixing is performed using a ball mill while cooling is performed. As media of the ball mill, zirconia balls with a diameter of 3 mm are used.

Next, in Step S14, the first mixture 901 formed in the preceding step is heated. In this formation method, the heating is performed under a dry air flow. The heating temperature can be higher than or equal to 850° C. and lower than 950° C., typically 900° C. The heating time can be longer than or equal to 2 hours and shorter than or equal to 20 hours, typically 10 hours. The heating in Step S14 is sometimes referred to as first heating, for distinction from other steps.

Next, mixing is performed in Step S15 in the case where the heating in Step S14 is performed separately using a plurality of containers. It is preferable that a bead mill, a ball mill, a mortar, a mix rotor, and/or a mixer be used for the mixing.

Through the above steps, a composite oxide 902 represented by LiₓM₂₋ₓO₂ is obtained (Step S16).

Next, in Step S21, a magnesium source and a fluorine source are prepared. In this formation method, magnesium fluoride and lithium fluoride are used as the magnesium source and the fluorine source. A mixture of magnesium fluoride and lithium fluoride has an eutectic point of approximately 742° C. and is likely to be liquid at a relatively low temperature. Thus, the mixture is suitable for a fusing agent that needs to function at a temperature lower than or equal to the decomposition temperature of the composite oxide.

Next, in Step S22, the magnesium source and the fluorine source are ground and mixed. Although there is no particular limitation on the method for grinding and mixing, the grinding and mixing are performed by a wet method using a ball mill in this formation method. As media of the ball mill, zirconia balls with a diameter of 1 mm are used. Next, if necessary, the mixing media can be removed through a sieve, and the solvent can be dried.

Through the above steps, an additive element source is obtained (Step S23).

Next, in Step S31, the composite oxide 902 and the additive element source are mixed to form a second mixture 903 (Step S32). For the mixing, the description of Step S12 can be referred to.

Next, in Step S33, the second mixture 903 is heated. In this formation method, the heating is performed under an oxygen flow. The heating in Step S33 is sometimes referred to as second heating, for distinction from other steps.

Through the above steps, the positive electrode active material particle 100 can be formed (Step S34). For this formation method, the formation method 1 and FIG. 3A can be referred to as appropriate.

This embodiment can be combined with the content of any of the other embodiments as appropriate.

### Embodiment 3

In this embodiment, structures of lithium-ion secondary batteries are described.

### [Positive Electrode]

A positive electrode includes a positive electrode active material layer and a positive electrode current collector. The positive electrode active material layer includes positive electrode active material particles and may further include at least one of a conductive additive and a binder. The positive electrode active material particles described in either of the above embodiments can be used.

The positive electrode active material particles described in either of the above embodiments and different positive electrode active material particles may be mixed and used.

Examples of the different positive electrode active material particles mentioned above include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

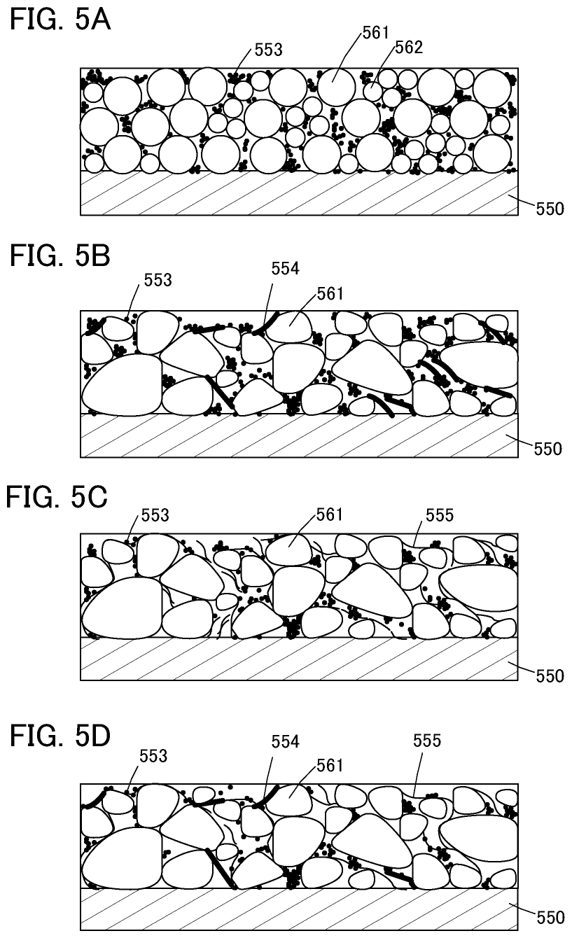

FIG. 5A illustrates an example of a schematic cross-sectional view of the positive electrode.

Metal foil can be used as a current collector 550, for example. The positive electrode can be formed by applying slurry onto the metal foil and drying the slurry. Note that pressing may be performed after drying. The positive electrode is obtained by forming an active material layer over the current collector 550. Although not illustrated, a conductive carbon coat layer is preferably provided between the active material and the current collector 550. Providing the conductive carbon coat layer can reduce the interface resistance between aluminum foil and the active material and variation in the interface resistance.

Slurry refers to a material solution that is used to form an active material layer over the current collector 550 and includes an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

Positive electrode active material particles 561 have a function of taking in and/or releasing lithium ions in accordance with charging and discharging. For the positive electrode active material particles 561 used as one embodiment of the present invention, a material with little deterioration due to discharging and charging even at a high charge voltage can be used.

For the positive electrode active material particles 561 used as one embodiment of the present invention, any material can be used as long as it shows little deterioration due to discharging and charging even at a high charge voltage, and any of the materials described in Embodiment 1 can be used. Note that for the positive electrode active material particles 561, two or more kinds of materials having different particle diameters can be used as long as the materials show little deterioration due to discharging and charging even at a high charge voltage.

A conductive additive is also referred to as a conductivity-imparting agent or a conductive material, and a carbon material can be used as the conductive additive. A conductive additive is attached between a plurality of active materials, whereby the plurality of active materials are electrically connected to each other, and the conductivity increases. Note that in this specification and the like, the term “attach” refers not only to a state where an active material and a conductive additive are physically in close contact with each other, but also to the following cases: a case where covalent bonding occurs, a case where bonding with the Van der Waals force occurs, a case where a conductive additive covers part of the surface of an active material, a case where a conductive additive is embedded in surface roughness of an active material, a case where an active material and a conductive additive are electrically connected to each other without being in contact with each other, and other cases.

Specific examples of carbon materials that can be used as the conductive additive include carbon black (e.g., furnace black, acetylene black, or graphite).

In FIG. 5A, carbon black 553 is illustrated as the conductive additive.

In the positive electrode of the lithium-ion secondary battery, a binder (a resin) may be mixed in order to adhere the current collector 550 such as metal foil and the active material to each other. The binder is also referred to as a binding agent. Since the binder is a high molecular material, a large amount of the binder lowers the proportion of the active material in the positive electrode, thereby reducing the discharge capacity of the lithium-ion secondary battery. Therefore, the amount of the binder mixed is preferably reduced to a minimum. In FIG. 5A, a region not filled with the positive electrode active material particles 561, a second active material 562, or the carbon black 553 indicates a space or the binder.

Although FIG. 5A illustrates an example in which the positive electrode active material particles 561 each have a spherical shape, there is no particular limitation. For example, the cross-sectional shape of the positive electrode active material particles 561 may be an ellipse, a rectangle, a trapezoid, a pyramid, a polygon with rounded corners, or an asymmetrical shape. For example, FIG. 5B illustrates an example in which the positive electrode active material particles 561 each have a polygon shape with rounded corners.

In the positive electrode in FIG. 5B, graphene 554 is used as a carbon material used as the conductive additive. In FIG. 5B, a positive electrode active material layer including the positive electrode active material particles 561, the graphene 554, and the carbon black 553 is formed over the current collector 550.

In the step of mixing the graphene 554 and the carbon black 553 to obtain an electrode slurry, the weight of the carbon black mixed is preferably 1.5 times to 20 times, further preferably 2 times to 9.5 times the weight of graphene.

When the graphene 554 and the carbon black 553 are mixed in the above range, the carbon black 553 is excellent in dispersion stability and less likely to be aggregated at the time of preparing the slurry. Furthermore, when the graphene 554 and the carbon black 553 are mixed in the above range, the electrode density can be higher than that of a positive electrode using only the carbon black 553 as a conductive additive. A higher electrode density leads to a higher capacity per unit weight. Specifically, the density of the positive electrode active material layer measured by gravimetry can be higher than or equal to 3.5 g/cc.

The electrode density is lower than that of a positive electrode containing only graphene as a conductive additive, but when a first carbon material (graphene) and a second carbon material (acetylene black) are mixed in the above range, fast charging can be achieved. Thus, use of such a mixed conductive additive for lithium-ion secondary batteries for vehicles is particularly effective.

FIG. 5C illustrates an example of a positive electrode using carbon fiber 555 instead of graphene. FIG. 5C illustrates an example different from that in FIG. 5B. With the use of the carbon fiber 555, aggregation of the carbon black 553 can be prevented and the dispersibility can be increased.

In FIG. 5C, a region not filled with the positive electrode active material particles 561, the carbon fiber 555, or the carbon black 553 indicates a space or a binder.

FIG. 5D illustrates another example of a positive electrode. FIG. 5D illustrates an example in which the carbon fiber 555 is used in addition to the graphene 554. With the use of both the graphene 554 and the carbon fiber 555, aggregation of carbon black such as the carbon black 553 can be prevented and the dispersibility can be further increased.

In FIG. 5D, a region not filled with the positive electrode active material particles 561, the carbon fiber 555, the graphene 554, or the carbon black 553 indicates a space or a binder.

A lithium-ion secondary battery can be fabricated by using any one of the positive electrodes in FIGS. 5A to 5D; setting, in a container (e.g., an exterior body or a metal can), a stack in which a separator is provided over the positive electrode and a negative electrode is provided over the separator; and filling the container with a liquid electrolyte.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder. The above-described rubber material dispersed in a dispersion medium can be used. For example, one or more of water, N-methylpyrrolidone (NMP), methanol, ethanol, acetone, tetrahydrofuran (THF), dimethylformamide (DMF), and dimethyl sulfoxide (DMSO) can be used as the dispersion medium.

As the binder, a water-soluble polymer can also be used, for example. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose may be used.

Two or more of the above materials may be used in combination for the binder.

In the case where the binder that covers or is in contact with the active material surface forms a film, the film is expected to serve also as a passivation film to suppress the decomposition of the electrolyte solution. Here, a passivation film refers to a film without electrical conductivity or a film with extremely low electrical conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### <Positive Electrode Current Collector>

For the current collector, a material that has high conductivity, such as a metal like aluminum, stainless steel, gold, platinum, aluminum, or titanium, or an alloy thereof, can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms a silicide by reacting with silicon may be used. Examples of the metal element that forms a silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive additive and a binder.

### <Negative Electrode Active Material>

As the negative electrode active material, for example, an alloy-based material and/or a carbon material can be used.

As the carbon material used as the negative electrode active material, one or more selected from graphite, graphitizing carbon (soft carbon), non-graphitizing carbon (hard carbon), carbon fiber (carbon nanotube), graphene, carbon black, and the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery using graphite can have a high operating voltage. In addition, graphite is preferable because of its advantages such as a relatively high capacity per unit volume, relatively small volume expansion, low cost, and a higher level of safety than that of lithium metal.

As the negative electrode active material, an element that enables charge and discharge reactions by alloying and dealloying reactions with lithium can be used. For example, one or more materials selected from silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Alternatively, a compound including any of the above elements may be used. Examples of the compound include titanium silicide, titanium silicon oxide, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound including the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the negative electrode active material, one or more oxides selected from titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), and molybdenum dioxide (MoO₂) can be used.

Still alternatively, as the negative electrode active material, Li₃₋ₓMₓN (M=Co, Ni, or Cu) with a Li₃N structure, which is a nitride including lithium and a transition metal, can be used. For example, Li_{2.6}Co_{0.4}N is preferable because of its high discharge capacity (900 mAh/g and 1890 mAh/cm³).

A nitride of lithium and a transition metal is preferably used, in which case lithium ions are contained in the negative electrode active material and thus the negative electrode active material can be used in combination with a material for the positive electrode active material particles which do not contain lithium ions, such as V₂O₅ or Cr₃O₈. Note that in the case of using a material including lithium ions for the positive electrode active material particles, the nitride of lithium and a transition metal can be used as the negative electrode active material by extracting the lithium ions included in the positive electrode active material particles in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

A combination of two or more of the above negative electrode active materials may be used; for example, a negative electrode active material in which graphite and silicon particles are mixed may be used. The silicon particles refer to silicon powders that are the negative electrode active material of the lithium-ion secondary battery, and the average diameter of the particle size distribution, i.e., the average particle diameter is around 100 nm; the silicon particles are referred to as nanosilicon particles in some cases. In order to obtain silicon particles to be used, it is preferable that a silicon source material be ground and particle diameters be adjusted to be uniform. The silicon particles can include at least one of silicon, silicon oxide, and silicon alloy. Although laser diffraction particle size distribution measurement can be typically used for measurement of a particle size, the measurement is not limited thereto. A major diameter of a particle cross section may be measured by analysis using a scanning electron microscope (SEM), a transmission electron microscope (TEM), or the like.

For the conductive additive and the binder that can be included in the negative electrode active material layer, materials similar to those for the conductive additive and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte Solution]

The electrolyte solution contains an organic solvent; the organic solvent is not necessarily a liquid at room temperature, e.g., 25° C. but may be a solid at room temperature or a semi-solid at room temperature. Note that the organic solvent is preferably a liquid in a wide temperature range from temperatures below freezing to high temperatures; however, the present invention is not limited thereto. The organic solvent may be a liquid, a solid, or a semi-solid in a wide temperature range from temperatures below freezing to high temperatures.

As the organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), 1,3-propanesultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The above-described organic solvent may contain an additive agent. The additive agent can inhibit a decomposition reaction of an electrolyte which might occur on a positive electrode surface or a negative electrode surface when a secondary battery operates at a high voltage and/or a high temperature. As the additive agent, for example, vinylene carbonate (VC), propane sultone (PS), tert-butylbenzene (TBB), fluoroethylene carbonate (FEC), or lithium bis(oxalate)borate (LiBOB) is preferably used. LiBOB is particularly preferable because it facilitates formation of a favorable coating film. VC or FEC is preferable because it forms a favorable coating film on a negative electrode at the time of aging the secondary battery or charging the secondary battery at the initial use, which improves the cycle performance.

PS has a highest occupied molecular orbital (HOMO) level and a lowest unoccupied molecular orbital (LUMO) level equivalent to those of EC and DEC; thus, PS is less likely to be oxidized and reduced even at a high cut-off voltage, and is likely to be a high molecule when decomposed on the surface of the positive electrode active material particle. Accordingly, PS is advantageous in that it is unlikely to be gasified by becoming a decomposition product with a small molecular weight. Thus, the electrolyte solution preferably includes PS at higher than or equal to 0.1 wt % and lower than or equal to 10 wt %, further preferably higher than or equal to 0.25 wt % and lower than or equal to 7.5 wt %.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC not including a substituent with an electron-withdrawing property. Thus, lithium ions are likely to be extracted from surfaces of a positive electrode active material particle and a negative electrode active material, which can reduce an internal resistance of a secondary battery. In addition, FEC has a deep HOMO level and is thus not easily oxidized, meaning high oxidation resistance. On the other hand, FEC disadvantageously has high viscosity. In view of this, a mixed organic solvent including not only FEC but also MTFP is preferably used for the electrolyte solution. MTFP, which is one of linear carbonates, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP) not including a substituent with an electron-withdrawing property, MTFP may solvate a lithium ion when used for the electrolyte solution. In the case of using a mixed organic solvent including both FEC and MTFP, y in the volume ratio FEC:MTFP=1:y is preferably greater than or equal to 2 and less than or equal to 20, further preferably greater than or equal to 4 and less than or equal to 9.

It is preferable that the above-described organic solvent be highly purified and include a small amount of dust particles or molecules other than constituent molecules of the organic solvent (hereinafter also simply referred to as impurities and include oxygen (O₂), water (H₂O), and moisture). It is preferable that generation of a reaction by-product in synthesis be inhibited through appropriate purification. Specifically, the impurity in the electrolyte solution is less than or equal to 100 ppm, preferably less than or equal to 50 ppm, further preferably less than 10 ppm. The concentration of moisture among the impurities can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” (Bruker Corporation) can be used. Among the five peaks of acetonitrile derived from acetonitrile-d₃ used in a solvent in the ¹H-NMR measurement, the center peak can be 1.94 ppm.

For example, in the case of MTFP, it is known that when ¹H-NMR is measured using an acetonitrile-d₃ solvent, four peaks appear at 6 of greater than or equal to 3.29 ppm and less than or equal to 3.43 ppm. However, in the case where another peak appears in the vicinity of the above range, for example, another peak appears at 6 of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharging or the like. An ionic liquid includes a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (Li(C₂O₄)₂, LiBOB) can be used, or two or more of these lithium salts can be used in an appropriate combination in an appropriate ratio.

The electrolyte solution used for the power storage device is preferably a highly-purified electrolyte solution with only a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer including any of them can be used. For example, PVDF-HFP, which is a copolymer of PVDF and hexafluoropropylene (HFP), can be used. The formed polymer may be porous.

In addition, as the electrolyte solution, a solid electrolyte containing an inorganic material such as a sulfide-based or oxide-based inorganic material, or a solid electrolyte containing a high molecular material such as a polyethylene oxide (PEO)-based polymer material can be used. When the solid electrolyte is used, a separator or a spacer is not necessary. Furthermore, the battery can be entirely solidified; accordingly, there is no risk of liquid leakage and thus the safety of the battery is dramatically improved.

### [Separator]

In the case where a separator is provided between the positive electrode and the negative electrode, a fiber including cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used as the separator, for example. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. The separator using polyimide is preferable because it can have a high porosity and can have a large thickness (typically, a thickness greater than or equal to 50 μm and less than or equal to 60 μm).

The separator is preferably processed into a bag-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

The use of a separator having a multilayer structure makes it possible to maintain the safety of the lithium-ion secondary battery even when the total thickness of the separator is small, so that the capacity per volume of the lithium-ion secondary battery can be increased.

### [Exterior Body]

For an exterior body included in the lithium-ion secondary battery, a metal material such as aluminum or a resin material can be used, for example. A film-like exterior body can also be used. As a film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be combined with the content of any of the other embodiments as appropriate.

### Embodiment 4

In this embodiment, embodiment examples of lithium-ion secondary batteries are described.

### [Laminated Lithium-Ion Secondary Battery]

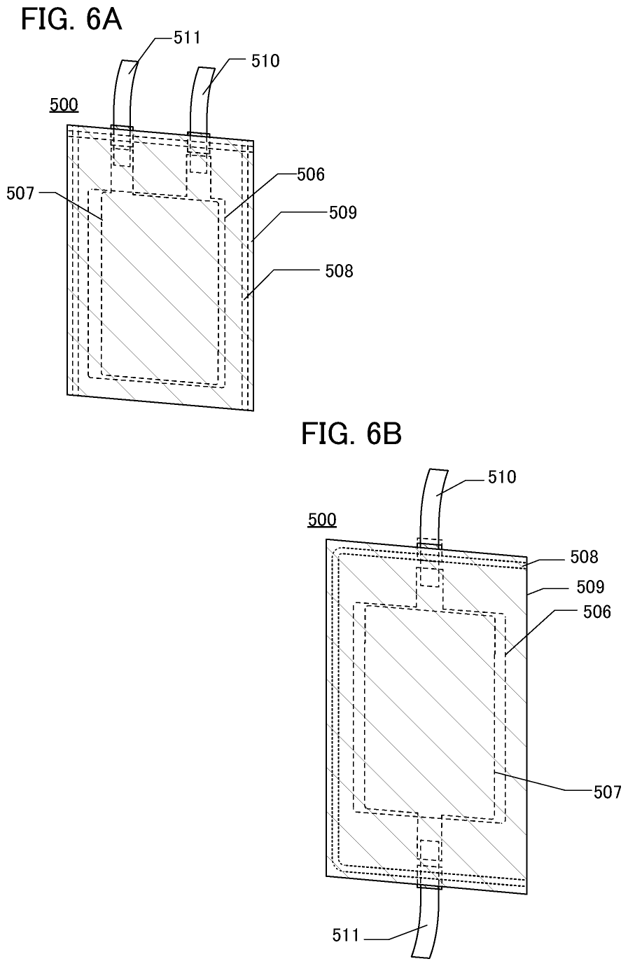

FIGS. 6A and 6B illustrate embodiment examples of a laminated lithium-ion secondary battery 500. FIGS. 6A and 6B are external views, and the lithium-ion secondary battery 500 includes the electrolyte solution and the separator described in the above embodiments (which are not illustrated in FIG. 6A or 6B), a negative electrode 506, and a positive electrode 507. In the lithium-ion secondary battery 500, the negative electrode 506 preferably has a larger area than the positive electrode 507. Furthermore, the lithium-ion secondary battery 500 includes a negative electrode lead electrode 510 electrically connected to the negative electrode 506 and a positive electrode lead electrode 511 electrically connected to the positive electrode 507. The electrolyte solution, the negative electrode 506, and the positive electrode 507 are held in an exterior body 509, and part of the negative electrode lead electrode 510 and part of the positive electrode lead electrode 511 protrude from the exterior body 509. A bonding region 508 is provided in part of the outer periphery of the exterior body 509. FIG. 6A illustrates an embodiment example in which the negative electrode lead electrode 510 and the positive electrode lead electrode 511 protrude from the same side of the exterior body 509, and the bonding region 508 is positioned at least on the side where the lead electrodes protrude and two sides adjacent to that side. FIG. 6B illustrates an embodiment example in which a side where the negative electrode lead electrode 510 protrudes from the exterior body 509 and a side where the positive electrode lead electrode 511 protrudes from the exterior body 509 face each other, and the bonding region 508 is positioned at least on the two sides where the lead electrodes protrude and a side sandwiched between the two sides. In FIGS. 6A and 6B, a side where the bonding region 508 is not positioned preferably corresponds to a side where the exterior body 509 is folded.

By including the positive electrode active material particles of one embodiment of the present invention, the laminated lithium-ion secondary battery 500 can be a secondary battery with high capacity, high discharge capacity, and excellent cycle performance.

### [Coin-Type Lithium-Ion Secondary Battery]

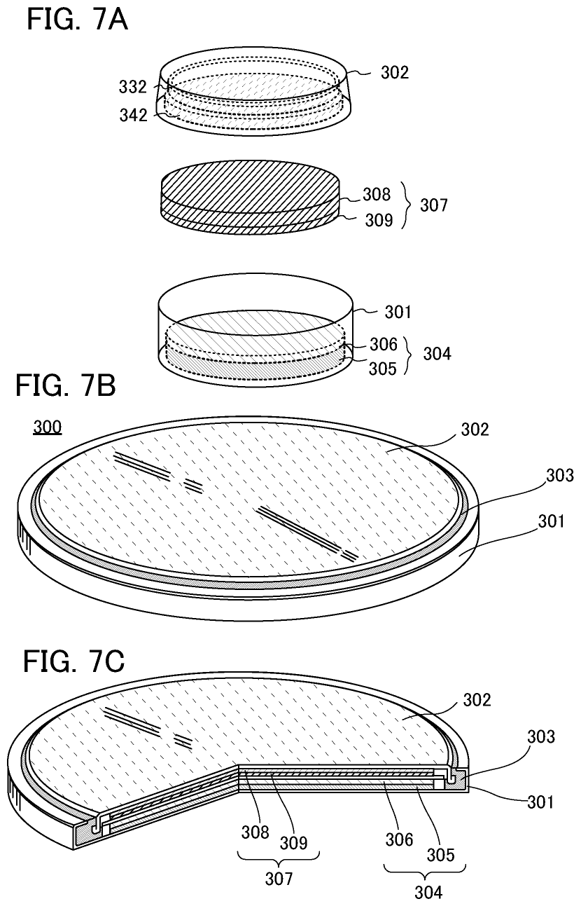

An example of a coin-type lithium-ion secondary battery is described here. FIG. 7A is an exploded perspective view of a coin-type (single-layer flat type) lithium-ion secondary battery, FIG. 7B is an external view thereof, and FIG. 7C is a cross-sectional view thereof. Coin-type lithium-ion secondary batteries are mainly used in small electronic devices. In this specification and the like, coin-type lithium-ion secondary batteries include button-type lithium-ion secondary batteries.

For easy understanding, FIG. 7A is a schematic view showing overlap (a vertical relation and a positional relation) between components. Thus, FIG. 7A and FIG. 7B do not completely correspond with each other.

FIG. 7A illustrates a state where a positive electrode 304, a negative electrode 307, a spacer 342, and a washer 332 overlap with each other and are sealed with a negative electrode can 302 and a positive electrode can 301. Note that FIG. 7A does not illustrate the electrolyte and the separator described in the above embodiments. The spacer 342 and the washer 332 are used to protect the inside or fix the position of the components inside the cans at the time when the positive electrode can 301 and the negative electrode can 302 are bonded with pressure. For the spacer 342 and the washer 332, stainless steel or an insulating material is used.

The positive electrode 304 has a stacked-layer structure in which a positive electrode active material layer 306 is formed over a positive electrode current collector 305.

FIG. 7B is a perspective view of a completed coin-type lithium-ion secondary battery 300.

In the coin-type lithium-ion secondary battery 300, the positive electrode can 301 doubling as a positive electrode terminal and the negative electrode can 302 doubling as a negative electrode terminal may be insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The positive electrode can 301 and the negative electrode can 302 are electrically connected to the positive electrode 304 and the negative electrode 307, respectively.

Note that only one surface of each of the positive electrode 304 and the negative electrode 307 used for the coin-type lithium-ion secondary battery 300 is preferably provided with an active material layer.

As illustrated in FIG. 7C, the positive electrode 304, the negative electrode 307, and the negative electrode can 302 are stacked in this order with the positive electrode can 301 positioned at the bottom, and then the positive electrode can 301 and the negative electrode can 302 are subjected to pressure bonding with the gasket 303 therebetween; as a result, the coin-type lithium-ion secondary battery 300 is manufactured.

By including the positive electrode active material particles of one embodiment of the present invention, the coin-type lithium-ion secondary battery 300 can be a secondary battery with high capacity, high discharge capacity, and excellent cycle performance.

### [Cylindrical Lithium-Ion Secondary Battery]

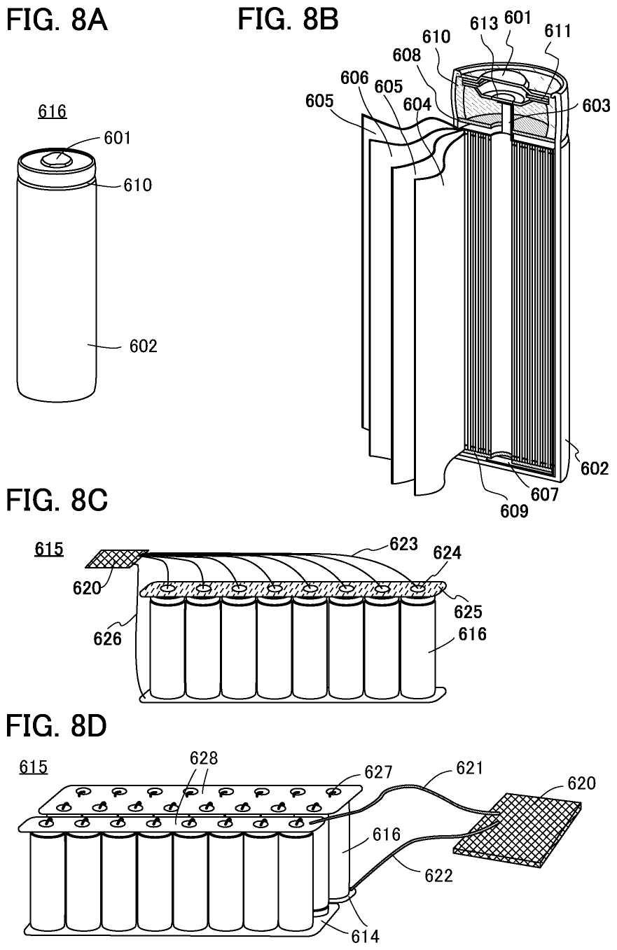

An example of a cylindrical lithium-ion secondary battery is described with reference to FIG. 8A. As illustrated in FIG. 8A, a cylindrical lithium-ion secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 8B is a diagram schematically illustrating a cross section of the cylindrical lithium-ion secondary battery. The cylindrical lithium-ion secondary battery illustrated in FIG. 8B includes the positive electrode cap (battery cap) 601 on the top surface and the battery can (outer can) 602 on the side surface and bottom surface. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like electrolyte layer 605 located therebetween is provided. Although not illustrated, the battery element is wound around a central axis. One end of the battery can 602 is closed and the other end thereof is opened. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte solution (not illustrated).

Since a positive electrode and a negative electrode that are used for a cylindrical storage battery are wound, active materials are preferably formed on both surfaces of a current collector. Note that although FIGS. 8A to 8D each illustrate the lithium-ion secondary battery 616 in which the height of the cylinder is larger than the diameter of the cylinder, one embodiment of the present invention is not limited thereto. In a lithium-ion secondary battery, the diameter of the cylinder may be larger than the height of the cylinder. Such a structure can reduce the size of a lithium-ion secondary battery, for example.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum, and the negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. A barium titanate (BaTiO₃)-based ceramic material or the like can be used for the PTC element.

FIG. 8C illustrates an example of a power storage system 615. The power storage system 615 includes a plurality of the lithium-ion secondary batteries 616 and is also referred to as a battery pack in some cases. The positive electrodes of the lithium-ion secondary batteries are in contact with and electrically connected to conductors 624 isolated by an insulator 625. The conductors 624 are electrically connected to a control circuit 620 through wirings 623. The negative electrodes of the lithium-ion secondary batteries are electrically connected to the control circuit 620 through a wiring 626. As the control circuit 620, a protection circuit for preventing overcharging or overdischarging can be used, for example.

FIG. 8D illustrates an example of the power storage system 615. The power storage system 615 includes the plurality of lithium-ion secondary batteries 616, and the plurality of lithium-ion secondary batteries 616 are sandwiched between a conductive plate 628 and a conductive plate 614. The plurality of lithium-ion secondary batteries 616 are electrically connected to the conductive plate 628 and the conductive plate 614 through a wiring 627. The plurality of lithium-ion secondary batteries 616 may be connected in parallel, connected in series, or connected in series after being connected in parallel. With the power storage system 615 including the plurality of lithium-ion secondary batteries 616, large electric power can be extracted.

The plurality of lithium-ion secondary batteries 616 may be connected in series after being connected in parallel.

A temperature control device may be provided between the plurality of lithium-ion secondary batteries 616. The lithium-ion secondary batteries 616 can be cooled with the temperature control device when overheated, whereas the lithium-ion secondary batteries 616 can be heated with the temperature control device when cooled too much. In this manner, the performance of the power storage system 615 is less likely to be influenced by the outside temperature.

In FIG. 8D, the power storage system 615 is electrically connected to the control circuit 620 through a wiring 621 and a wiring 622. The wiring 621 is electrically connected to the positive electrodes of the plurality of lithium-ion secondary batteries 616 through the conductive plate 628, and the wiring 622 is electrically connected to the negative electrodes of the plurality of lithium-ion secondary batteries 616 through the conductive plate 614.

By including the positive electrode active material particles of one embodiment of the present invention, the cylindrical lithium-ion secondary battery 616 can be a secondary battery with high capacity, high discharge capacity, and excellent cycle performance.

### [Other Structure Examples of Lithium-Ion Secondary Battery]

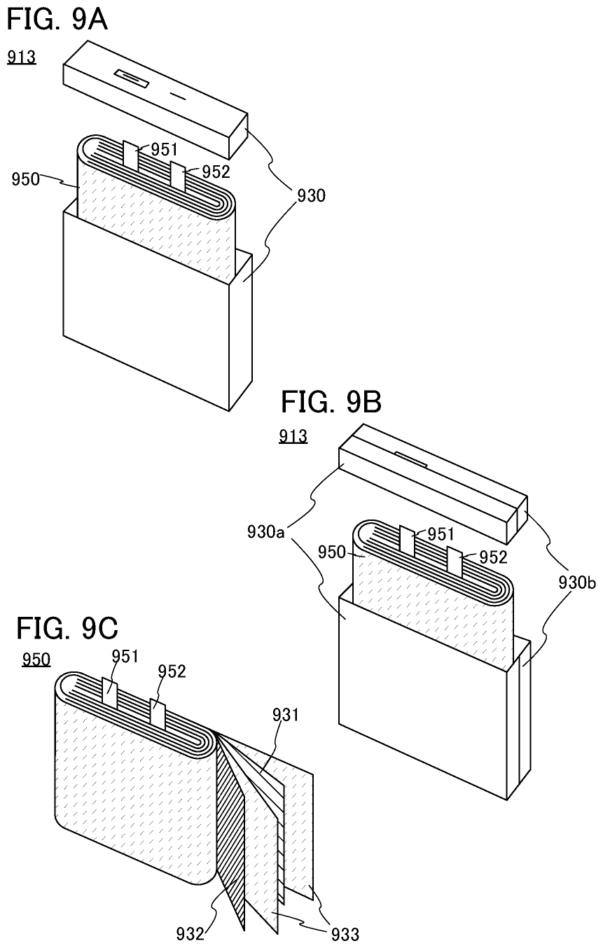

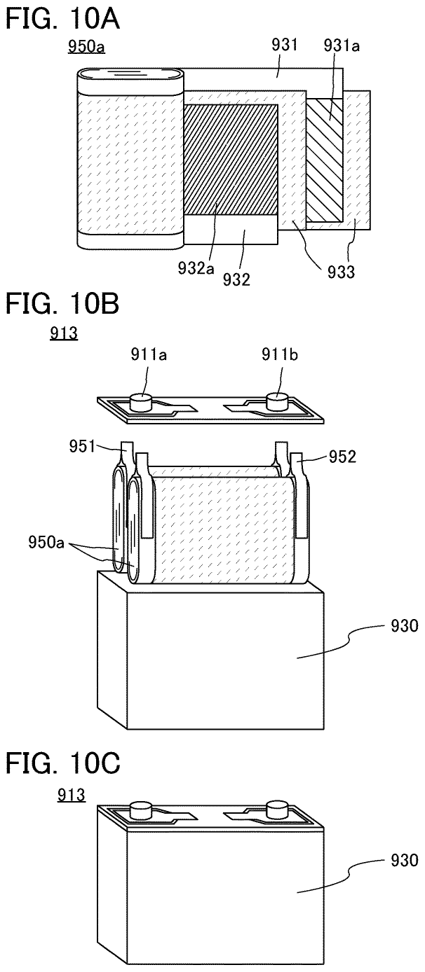

Structure examples of lithium-ion secondary batteries are described with reference to FIGS. 9A to 9C and FIGS. 10A to 10C.

A lithium-ion secondary battery 913 illustrated in FIG. 9A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 9A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum), a composite material of a metal and a resin, or the like can be used.

Note that as illustrated in FIG. 9B, the housing 930 in FIG. 9A may be formed using a plurality of materials. For example, in the lithium-ion secondary battery 913 illustrated in FIG. 9B, a housing 930a and a housing 930b are attached to each other, and the wound body 950 is provided in a region surrounded by the housing 930a and the housing 930b.

For the housing 930a, an insulating material can be used. In particular, when a material such as an organic resin is used for the side on which an antenna is formed, blocking of an electric field by the lithium-ion secondary battery 913 can be inhibited. When an electric field is not significantly blocked by the housing 930a, an antenna may be provided inside the housing 930a. For the housing 930b, a metal material can be used, for example.

FIG. 9C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 10A to 10C, the lithium-ion secondary battery 913 may include a wound body 950a. The wound body 950a illustrated in FIG. 10A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 10B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 10C, the wound body 950a is covered with the housing 930, whereby the lithium-ion secondary battery 913 is completed. The housing 930 is preferably provided with a safety valve, an overcurrent protection element, and the like. The safety valve is a valve to be released by a predetermined internal pressure of the housing 930 in order to prevent the battery from exploding.

As illustrated in FIG. 10B, the lithium-ion secondary battery 913 may include a plurality of the wound bodies 950a. The use of the plurality of wound bodies 950a enables the lithium-ion secondary battery 913 to have higher charge and discharge capacities. The description of the lithium-ion secondary battery 913 illustrated in FIGS. 9A to 9C can be referred to for the other components of the lithium-ion secondary battery 913 illustrated in FIGS. 10A and 10B.

By including the positive electrode active material particles of one embodiment of the present invention, the lithium-ion secondary battery 913 with the wound body can be a secondary battery with high capacity, high discharge capacity, and excellent cycle performance.

The content of this embodiment can be combined with the content of any of the other embodiments as appropriate.

### Embodiment 5

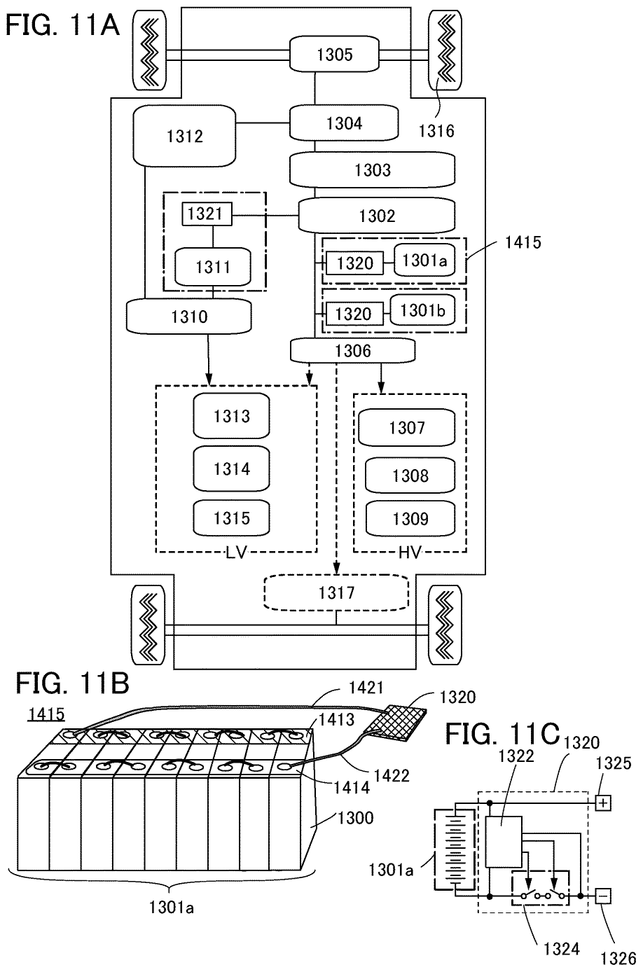

In this embodiment, an example of application to an electric vehicle (EV) will be described with reference to FIGS. 11A to 11C.

As illustrated in FIG. 11A, the electric vehicle is provided with first batteries 1301a and 1301b as main lithium-ion secondary batteries for driving and a second battery 1311 that supplies electric power to an inverter 1312 for starting a motor 1304. By including the positive electrode active material particles of one embodiment of the present invention, the first batteries 1301a and 1301b can each be a secondary battery with high capacity, high discharge capacity, and excellent cycle performance.

The second battery 1311 is also referred to as a cranking battery (also referred to as a starter battery). The second battery 1311 only needs high output and does not necessarily have high capacity, and the capacity of the second battery 1311 is lower than that of the first batteries 1301a and 1301b.

The internal structure of the first battery 1301a may be a wound structure or a stacked-layer structure.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of lithium-ion secondary batteries, large electric power can be extracted. The plurality of lithium-ion secondary batteries may be connected in parallel, connected in series, or connected in series after being connected in parallel. The plurality of lithium-ion secondary batteries are also referred to as an assembled battery.

In order to cut off electric power from the plurality of lithium-ion secondary batteries, the lithium-ion secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC/DC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DC/DC circuit 1310.

The first battery 1301a is described with reference to FIG. 11B.

FIG. 11B illustrates an example in which nine rectangular lithium-ion secondary batteries 1300 form one battery pack 1415. The nine rectangular lithium-ion secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium-ion secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of lithium-ion secondary batteries are preferably fixed by the fixing portions 1413 and 1414 and a battery container box, for example. Furthermore, the one electrode is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a battery operating system or a battery oxide semiconductor (BTOS) in some cases.

A metal oxide functioning as an oxide semiconductor is preferably used. For example, as the oxide, a metal oxide such as an In-M2-Zn oxide (the element M2 is one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M2-Zn oxide that can be used as the oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction.

The control circuit portion 1320 preferably includes a transistor using an oxide semiconductor because the transistor using an oxide semiconductor can be used in a low-temperature environment. For the process simplicity, the control circuit portion 1320 may be formed using transistors of the same conductivity type. A transistor using an oxide semiconductor in its semiconductor layer has an operating ambient temperature range from −40° C. to 150° C., both inclusive, which is wider than that of a single crystal Si transistor, and thus shows a smaller change in characteristics than the single crystal Si transistor when the lithium-ion secondary battery is heated. The off-state current of the transistor using an oxide semiconductor is lower than the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the lithium-ion secondary battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the lithium-ion secondary battery can be extremely small in size.

A micro-short circuit refers to a minute short circuit caused in a lithium-ion secondary battery. One of the supposed causes of a micro-short circuit is as follows. Uneven distribution of positive electrode active material particles due to charging and discharging performed multiple times causes local current concentration at part of the positive electrode and part of the negative electrode. Another supposed cause is generation of a by-product due to a side reaction.

It can be said that the control circuit portion 1320 not only detects a micro-short circuit but also senses a terminal voltage of the lithium-ion secondary battery and controls the charge and discharge state of the lithium-ion secondary battery. For example, to prevent overcharging, an output transistor of a charge circuit and an interruption switch can be turned off substantially at the same time.

FIG. 11C illustrates an example of a block diagram of the battery pack 1415 illustrated in FIG. 11B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the lithium-ion secondary battery to be used, and imposes the upper limit of current from the outside, the upper limit of output current to the outside, and the like. The range from the lower limit voltage to the upper limit voltage of the lithium-ion secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed with a combination of an n-channel transistor and a p-channel transistor. The switch portion 1324 is not limited to a switch including a Si transistor using single crystal silicon; the switch portion 1324 may be formed using, for example, a power transistor including germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element including an OS transistor can be freely placed by being stacked over a circuit including a Si transistor, for example; hence, integration can be easy. The control circuit portion 1320 including an OS transistor can be stacked and integrated over the switch portion 1324 so as to form one chip, which enables reduction in size.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead storage battery is usually used for the second battery 1311 due to cost advantage. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

Although this embodiment describes an example in which lithium-ion secondary batteries are used as both the first battery 1301a and the second battery 1311, a lead storage battery, an all-solid-state battery, or an electric double layer capacitor may be used as the second battery 1311. By including the positive electrode active material particles of one embodiment of the present invention, the above-described lithium-ion secondary batteries can each be a secondary battery with high capacity, high discharge capacity, and excellent cycle performance.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a lithium-ion secondary battery used, so that fast charging can be performed.

Although not shown, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet (50 kW), for example. Furthermore, charging can be performed with electric power supplied from external charge equipment by a contactless power feeding method or the like.

Next, examples in which the lithium-ion secondary battery of one embodiment of the present invention is mounted on a vehicle, typically a transport vehicle, will be described.

Mounting the lithium-ion secondary battery on vehicles can achieve next-generation clean energy vehicles such as hybrid vehicles (HVs), electric vehicles (EVs), and plug-in hybrid vehicles (PHVs). The lithium-ion secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

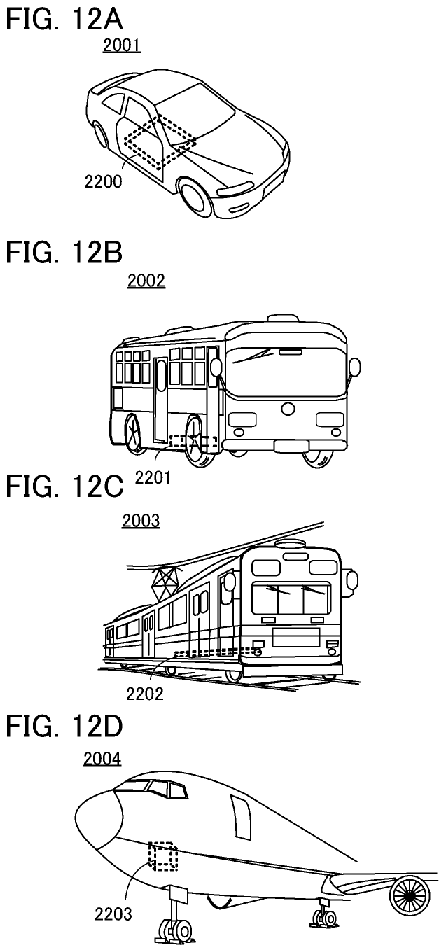

FIGS. 12A to 12D illustrate examples of transport vehicles using one embodiment of the present invention. An automobile 2001 illustrated in FIG. 12A is an electric vehicle that runs on the power of an electric motor. Alternatively, the automobile 2001 is a hybrid vehicle capable of driving using either an electric motor or an engine as appropriate. In the case where the lithium-ion secondary battery is mounted on the vehicle, an example of the lithium-ion secondary battery described in the above embodiment is provided at one position or several positions. By including the positive electrode active material particles of one embodiment of the present invention, the lithium-ion secondary battery mounted on the vehicle can be a secondary battery with high capacity, high discharge capacity, and excellent cycle performance.

The automobile 2001 illustrated in FIG. 12A includes a battery pack 2200, and the battery pack includes a battery module in which a plurality of lithium-ion secondary batteries are connected to each other. The battery pack 2200 preferably further includes a charge control device that is electrically connected to the battery module.

The automobile 2001 can be charged when the lithium-ion secondary battery included in the automobile 2001 is supplied with electric power from external charge equipment by a plug-in system, a contactless charge system, or the like. In charging, a given method such as CHAdeMO (registered trademark) or Combined Charging System can be employed as a charge method, the standard of a connector, or the like as appropriate. As the external charge equipment, a charge station provided in a commerce facility, a power source in a house, and the like can be given. For example, with use of the plug-in technique, the power storage device mounted on the automobile 2001 can be charged by being supplied with electric power from the outside. Charging can be performed by converting AC power into DC power through a converter such as an AC/DC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when moving. In addition, the contactless power feeding system may be utilized to perform transmission and reception of electric power between two vehicles. Furthermore, a solar cell may be provided in the exterior of the vehicle to charge the lithium-ion secondary battery while the vehicle is stopped or while the vehicle is moving. To supply electric power in such a contactless manner, an electromagnetic induction method or a magnetic resonance method can be used.

FIG. 12B illustrates a large transporter 2002 having a motor controlled by electricity as an example of a transport vehicle. A battery module of the transporter 2002 includes, for example, a cell unit of four lithium-ion secondary batteries with a nominal voltage higher than or equal to 3.0 V and lower than or equal to 5.0 V, and 48 cells that are connected in series to have a maximum voltage of 170 V. A battery pack 2201 has the same function as the battery pack illustrated in FIG. 11B except, for example, the number of lithium-ion secondary batteries; thus, the description is omitted. By including the positive electrode active material particles of one embodiment of the present invention, the lithium-ion secondary batteries in the battery pack 2201 can each be a secondary battery with high capacity, high discharge capacity, and excellent cycle performance.

FIG. 12C illustrates a large transport vehicle 2003 having a motor controlled by electricity as an example. A battery module of the transport vehicle 2003 can have 100 or more lithium-ion secondary batteries with a nominal voltage higher than or equal to 3.0 V and lower than or equal to 5.0 V that are connected in series to have a maximum voltage of 600 V. A battery pack 2202 of the transport vehicle 2003 has the same function as the battery pack 1415 illustrated in FIG. 11B except, for example, the number of cells connected in series, the number of cells in the battery module, or the like; thus, the description is omitted. By including the positive electrode active material particles of one embodiment of the present invention, the lithium-ion secondary batteries of the battery module can each be a secondary battery with high capacity, high discharge capacity, and excellent cycle performance.

FIG. 12D illustrates an aircraft 2004 having a combustion engine as an example. The aircraft 2004 illustrated in FIG. 12D can also be regarded as a kind of transport vehicle because it has wheels for takeoff and landing, and includes a battery pack 2203 that includes a charge control device and a battery module configured by connecting a plurality of lithium-ion secondary batteries.

The battery module of the aircraft 2004 includes, for example, eight 4-V lithium-ion secondary batteries that are connected in series to have a maximum voltage of 32 V. The battery pack 2203 has the same function as the battery pack illustrated in FIG. 11B except, for example, the number of lithium-ion secondary batteries in the battery module; thus, the description is omitted.

The content of this embodiment can be combined with the content of any of the other embodiments as appropriate.

### Embodiment 6

In this embodiment, examples in which a vehicle such as a motorcycle or a bicycle is provided with the lithium-ion secondary battery of one embodiment of the present invention will be described.

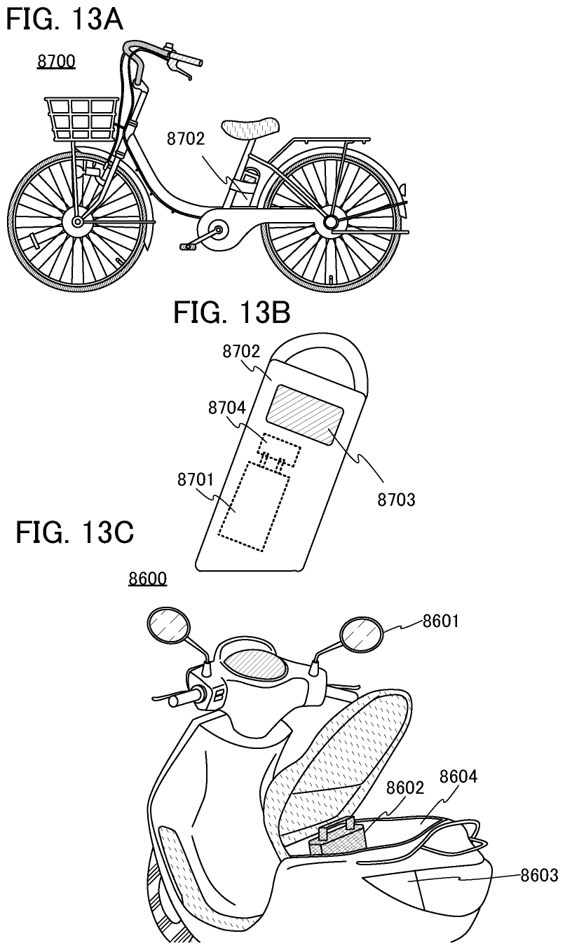

FIG. 13A illustrates an example of an electric bicycle using the lithium-ion secondary battery of one embodiment of the present invention. The lithium-ion secondary battery of one embodiment of the present invention can be used for an electric bicycle 8700 illustrated in FIG. 13A. The lithium-ion secondary battery of one embodiment of the present invention may include a protection circuit.

The electric bicycle 8700 includes a power storage device 8702. The power storage device 8702 can supply electricity to a motor that assists a rider. The power storage device 8702 is portable, and FIG. 13B illustrates the state where the power storage device 8702 is removed from the electric bicycle. A plurality of lithium-ion secondary batteries 8701 of one embodiment of the present invention are incorporated in the power storage device 8702, and the remaining battery capacity and the like can be displayed on a display portion 8703. By including the positive electrode active material particles of one embodiment of the present invention, the lithium-ion secondary batteries 8701 can each be a secondary battery with high capacity, high discharge capacity, and excellent cycle performance.

The power storage device 8702 includes a control circuit 8704 capable of charge control or anomaly detection for the lithium-ion secondary battery. The control circuit 8704 is electrically connected to a positive electrode and a negative electrode of the lithium-ion secondary battery 8701. The control circuit 8704 can contribute greatly to elimination of accidents due to lithium-ion secondary batteries, such as fires.

FIG. 13C illustrates an example of a motorcycle including the lithium-ion secondary battery of one embodiment of the present invention. A motor scooter 8600 illustrated in FIG. 13C includes a power storage device 8602, side mirrors 8601, and indicators 8603. The power storage device 8602 can supply electricity to the indicators 8603. By including the positive electrode active material particles of one embodiment of the present invention, the lithium-ion secondary battery can be a secondary battery with high capacity, high discharge capacity, and excellent cycle performance.

In the motor scooter 8600 illustrated in FIG. 13C, the power storage device 8602 can be stored in an under-seat storage unit 8604. The power storage device 8602 can be stored in the under-seat storage unit 8604 even when the under-seat storage unit 8604 is small.

The content of this embodiment can be combined with the content of any of the other embodiments as appropriate.

### Embodiment 7

In this embodiment, examples of electronic devices each including the lithium-ion secondary battery of one embodiment of the present invention will be described. Examples of electronic devices including the lithium-ion secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

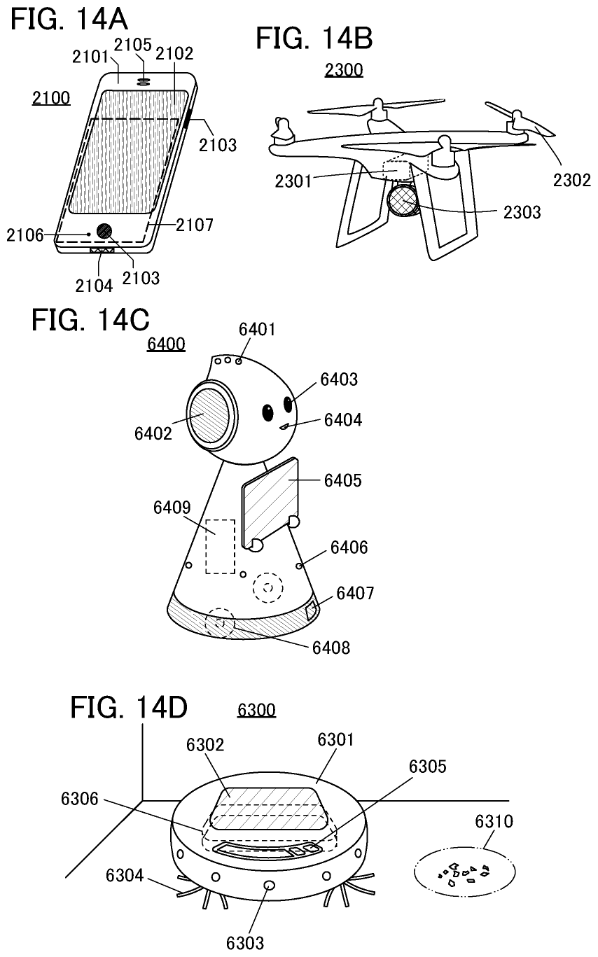

FIG. 14A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a lithium-ion secondary battery 2107. By including the positive electrode active material particles of one embodiment of the present invention, the lithium-ion secondary battery can be a secondary battery with high capacity, high discharge capacity, and excellent cycle performance.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a body temperature sensor; a touch sensor; a pressure sensitive sensor; or an acceleration sensor is preferably mounted, for example.

FIG. 14B illustrates an unmanned aircraft 2300 including a plurality of rotors 2302. The unmanned aircraft 2300 is sometimes also referred to as a drone. The unmanned aircraft 2300 includes a lithium-ion secondary battery 2301 of one embodiment of the present invention, a camera 2303, and an antenna (not illustrated). The unmanned aircraft 2300 can be remotely controlled through the antenna. By including the positive electrode active material particles of one embodiment of the present invention, the lithium-ion secondary battery can be a secondary battery with high capacity, high discharge capacity, and excellent cycle performance.

FIG. 14C illustrates an example of a robot. A robot 6400 illustrated in FIG. 14C includes a lithium-ion secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the lithium-ion secondary battery 6409 of one embodiment of the present invention and a semiconductor device or an electronic component. By including the positive electrode active material particles of one embodiment of the present invention, the lithium-ion secondary battery can be a secondary battery with high capacity, high discharge capacity, and excellent cycle performance.

FIG. 14D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a lithium-ion secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the lithium-ion secondary battery 6306 of one embodiment of the present invention and a semiconductor device or an electronic component. By including the positive electrode active material particles of one embodiment of the present invention, the lithium-ion secondary battery can be a secondary battery with high capacity, high discharge capacity, and excellent cycle performance.

This embodiment can be implemented in appropriate combination with any of the other embodiments.

### Embodiment 8

In this embodiment, examples of space equipment including the lithium-ion secondary battery of one embodiment of the present invention will be described.

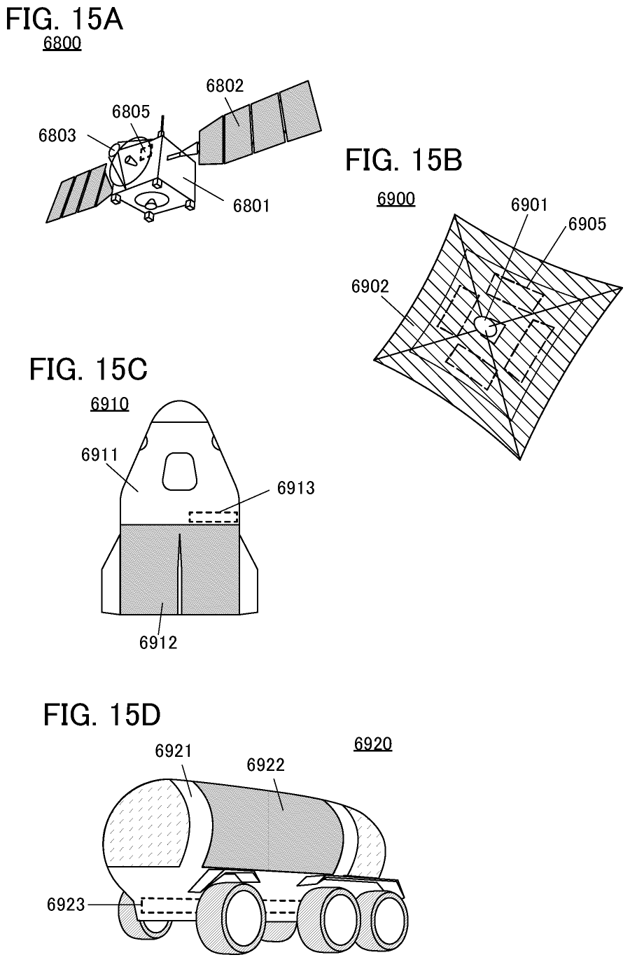

FIG. 15A illustrates an artificial satellite 6800 as an example of space equipment. The artificial satellite 6800 includes a body 6801, a solar panel 6802, an antenna 6803, and a lithium-ion secondary battery 6805. Such a solar panel is referred to as a solar cell module in some cases.

When the solar panel 6802 is irradiated with sunlight, electric power required for operation of the artificial satellite 6800 is generated. However, for example, in the situation where the solar panel is not irradiated with sunlight or the situation where the amount of sunlight with which the solar panel is irradiated is small, the amount of generated electric power is small. Accordingly, a sufficient amount of electric power required for operation of the artificial satellite 6800 might not be generated. In order to operate the artificial satellite 6800 even with a small amount of generated electric power, the artificial satellite 6800 is preferably provided with the lithium-ion secondary battery 6805. By including the positive electrode active material particles of one embodiment of the present invention, the lithium-ion secondary battery can be a secondary battery with high capacity, high discharge capacity, and excellent cycle performance.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured. Thus, the artificial satellite 6800 can make up part of a satellite positioning system.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of detecting thermal infrared rays emitted from the surface of the earth. Thus, the artificial satellite 6800 can function as an earth observing satellite, for example.

FIG. 15B illustrates a probe 6900 including a solar sail as an example of space equipment. The probe 6900 includes a body 6901, a solar sail 6902, and a lithium-ion secondary battery 6905. By including the positive electrode active material particles of one embodiment of the present invention, the lithium-ion secondary battery can be a secondary battery with high capacity, high discharge capacity, and excellent cycle performance. When photons emitted from the sun are incident on the surface of the solar sail 6902, the momentum is transmitted to the solar sail 6902. Hence, the surface of the solar sail 6902 preferably includes a thin film with high reflectance and further preferably faces in the direction of the sun.

The solar sail 6902 may be designed such that the solar sail 6902 is furled in a small size until it goes beyond the earth's atmosphere, and is unfurled to have a large sheet-like shape as illustrated in FIG. 15B in the space beyond the earth's atmosphere (outer space).

FIG. 15C illustrates a spacecraft 6910 as an example of space equipment. The spacecraft 6910 includes a body 6911, a solar panel 6912, and a lithium-ion secondary battery 6913. By including the positive electrode active material particles of one embodiment of the present invention, the lithium-ion secondary battery can be a secondary battery with high capacity, high discharge capacity, and excellent cycle performance. The body 6911 can include a pressurized cabin and an unpressurized cabin, for example. The pressurized cabin may be designed so that a crew can get into the cabin. Electric power that is generated by irradiation of the solar panel 6912 with sunlight can be stored in the lithium-ion secondary battery 6913.

FIG. 15D illustrates a rover 6920 as an example of space equipment. The rover 6920 includes a body 6921 and a lithium-ion secondary battery 6923. By including the positive electrode active material particles of one embodiment of the present invention, the lithium-ion secondary battery can be a secondary battery with high capacity, high discharge capacity, and excellent cycle performance. The rover 6920 may include a solar panel 6922.

The rover 6920 may be designed so that a crew can get into the rover. Electric power that is generated by irradiation of the solar panel 6922 with sunlight may be stored in the lithium-ion secondary battery 6923, or electric power generated by another power source such as a fuel cell or a radioisotope thermoelectric generator, for example, may be stored in the lithium-ion secondary battery 6923.

The content of this embodiment can be combined with the content of any of the other embodiments as appropriate.

### Example

In this example, positive electrode active material particles were formed by heating after adding fluorine and magnesium as additive elements to L_{1.2}Mn_{0.6}Ni_{0.2}O₂ used as a layered lithium-rich oxide represented by LiₓM₂₋ₓO₂ (Mis one or more selected from Mn, Ni, Co, Cr, Mo, Nb, V, Fe, Ti, and Ru; 1<x<2), and the characteristics of the positive electrode active material particles were evaluated.

### <Formation of Positive Electrode Active Material>

A method for forming the positive electrode active material particles in this example will be described with reference to the formation method illustrated in FIG. 4.

First, lithium carbonate, manganese carbonate, and nickel carbonate were prepared respectively as the Li source, the Mn source, and the Ni source in Step S11. These materials were weighed such that the molar ratio of Li to Mn to Ni was 1.2:0.6:0.2.

Next, the mixing in Step S12 was performed by a wet method using a ball mill and dehydrated acetone as a solvent while cooling was performed. As media of the ball mill, zirconia balls with a diameter of 3 mm were used, and the mixing was performed for 2 hours. After that, dehydrated acetone was dried in a drying furnace at 55° C., and the mixing media were removed through a sieve, whereby the first mixture was obtained.

Next, as the first heating in Step S14, the first mixture was put in a square alumina saggar, which was then covered with a lid, and heating was then performed under a dry air flow using a muffle furnace. The heating was performed at 1000° C. for 10 hours. The temperature rising rate was 200° C./h. The temperature dropping rate was lower than or equal to 200° C./h.

Through the above steps, a composite oxide whose composition estimated from the atomic ratio of the raw materials is represented by Li_{1.2}Mn_{0.6}Ni_{0.2}O₂ was obtained. This composite oxide is Sample 1.

Next, magnesium fluoride and lithium fluoride were prepared respectively as the Mg source and the F source in Step S21. These materials were weighed such that the molar ratio of LiF to MgF₂ was 1:3.

Next, the mixing in Step S22 was performed by a wet method using a ball mill and dehydrated acetone as a solvent. As media of the ball mill, zirconia balls with a diameter of 1 mm were used, and the mixing was performed for 20 hours. After that, dehydrated acetone was dried in a drying furnace at 55° C., and the mixing media were removed through a sieve, whereby the additive element source was obtained.

Next, as the mixing in Step S31, the composite oxide of Sample 1, magnesium fluoride, and lithium fluoride were weighed such that the molar ratio of Li_{1.2}Mn_{0.6}Ni_{0.2}O₂ to MgF₂ to LiF was 3:0.03:0.01, and were mixed by a dry method using a ball mill. As media of the ball mill, zirconia balls with a diameter of 1 mm were used, and the mixing was performed for 20 minutes. After that, the mixing media were removed through a sieve, whereby the second mixture was obtained.

Next, as the second heating in Step S33, the second mixture was put in an alumina crucible, which was then covered with a lid, and heating was then performed under an oxygen flow using a muffle furnace. The heating was performed at 900° C. for 20 hours. The temperature rising rate was 200° C./h. The temperature dropping rate was lower than or equal to 200° C./h.

The positive electrode active material particles formed through the above steps are Sample 2.

Sample 11 was formed in the same manner as Sample 1 except that the temperature of the first heating was 900° C. Sample 12 was formed in the same manner as Sample 2 except that the temperature of the first heating was 900° C. Table 2 shows the formation conditions of Samples 1, 2, 11, and 12.

TABLE 2

| | | Conditions of | Additive element | Conditions of |
|---|---|---|---|---|
| Sample name | Liₓ M₂₋ₓ O₂ | first heating | source | second heating |
| Sample 1 | Li_{1.2}Mn_{0.6}Ni_{0.2}O₂ | 1000° C., 10 h | — | — |
| Sample 2 | Li_{1.2}Mn_{0.6}Ni_{0.2}O₂ | 1000° C., 10 h | LiF, MgF₂ | 900° C., 20 h |
| Sample 11 | Li_{1.2}Mn_{0.6}Ni_{0.2}O₂ | 900° C., 10 h | — | — |
| Sample 12 | Li_{1.2}Mn_{0.6}Ni_{0.2}O₂ | 900° C., 10 h | LiF, MgF₂ | 900° C., 20 h |

### <SEM>

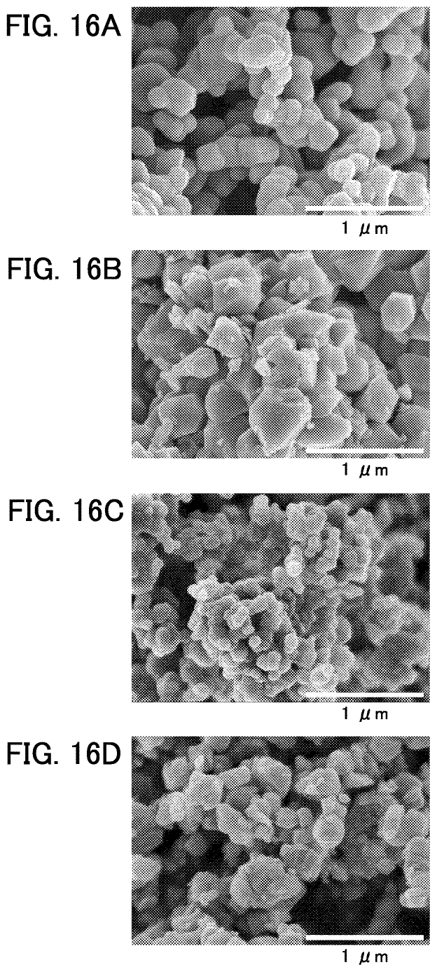

SEM images of Samples 1, 2, 11, and 12 were obtained for evaluation of the shapes of the positive electrode active material particles. FIG. 16A shows a SEM image of Sample 1; FIG. 16B, Sample 2; FIG. 16C, Sample 11; and FIG. 16D, Sample 12.

As shown in FIGS. 16A to 16D, the particle size tends to be increased through the additive element mixing and the second heating. The particle size of Sample 2 is larger than that of Sample 1, and the particle size of Sample 12 is larger than that of Sample 11. However, Sample 12 subjected to the first heating at 900° C. was inhibited from having an increase in particle size even through the additive element mixing and the second heating.

### <Charge and Discharge Curves and Charge and Discharge Cycle Performances>

Next, half cells using the positive electrode active material particles of Samples 2, 11, and 12 were fabricated and subjected to a charge and discharge cycle test for evaluation of their electrochemical characteristics.

### [Formation of Positive Electrode]

Samples 2, 11, and 12 described above were prepared as positive electrode active material particles, acetylene black (AB) was prepared as a conductive material, and poly(vinylidene fluoride) (PVDF) was prepared as a binding agent. The PVDF prepared was one dissolved in N-methyl-2-pyrrolidone (NMP) at a weight ratio of 5%. Then, the positive electrode active material, AB, and PVDF were mixed at a weight ratio of 90:5:5 to form a slurry, and the slurry was applied to an aluminum positive electrode current collector. As a solvent of the slurry, NMP was used. After the application of the slurry to the positive electrode current collector, the solvent was volatilized.

After that, pressing was performed with a roller press machine to increase the density of a positive electrode active material layer over the positive electrode current collector. The pressing was performed with a linear pressure of 210 kN/m. Note that the temperature of each of an upper roller and a lower roller of the roller press machine was 120° C.

The positive electrode after the pressing was stamped out to have a diameter of 12 mmφ. The loading amount of the positive electrode active material per unit area of the positive electrode was approximately 5 mg/cm². Through such a formation method, the positive electrodes including Samples 2, 11, and 12 were formed.

### [Fabrication of Half Cell]

Coin-type half cells (also referred to as coin cells) each including one of the above-described positive electrodes, lithium metal foil, a separator, an electrolyte solution, a coin cell positive electrode can, and a coin cell negative electrode can were fabricated. The coin-type half cells were each fabricated using a member for CR2032. For example, each coin cell can have a diameter (di in JIS C 8515:2017) of approximately 20 mm and a height (hi in JIS C 8515:2017) of approximately 3.2 mm, and preferably has a diameter greater than or equal to 19.5 mm and less than or equal to 20.5 mm and a height greater than or equal to 2.8 mm and less than or equal to 3.5 mm, further preferably a diameter greater than or equal to 19.7 mm and less than or equal to 20 mm and a height greater than or equal to 2.9 mm and less than or equal to 3.2 mm.

As the electrolyte solution, a solution in which ethylene carbonate (EC) and diethyl carbonate (DEC) were mixed at a volume ratio of 3:7 and 1 mol/L lithium hexafluorophosphate (LiPF₆) was dissolved was used.

As the separator, glass fiber filter paper (GF/C, produced by Whatman Ltd.) was used.

A charge and discharge cycle test was performed on the half cells formed above. Charging was performed at a constant current (CC) with 30 mA/g until a termination voltage of 4.8 V. Discharging was performed at CC with 30 mA/g until a termination voltage of 2.0 V. The ambient temperature was 25° C. Unless otherwise specified, the current and the charge and discharge capacities in this example and the like are given as values per unit weight of the positive electrode active material particles.

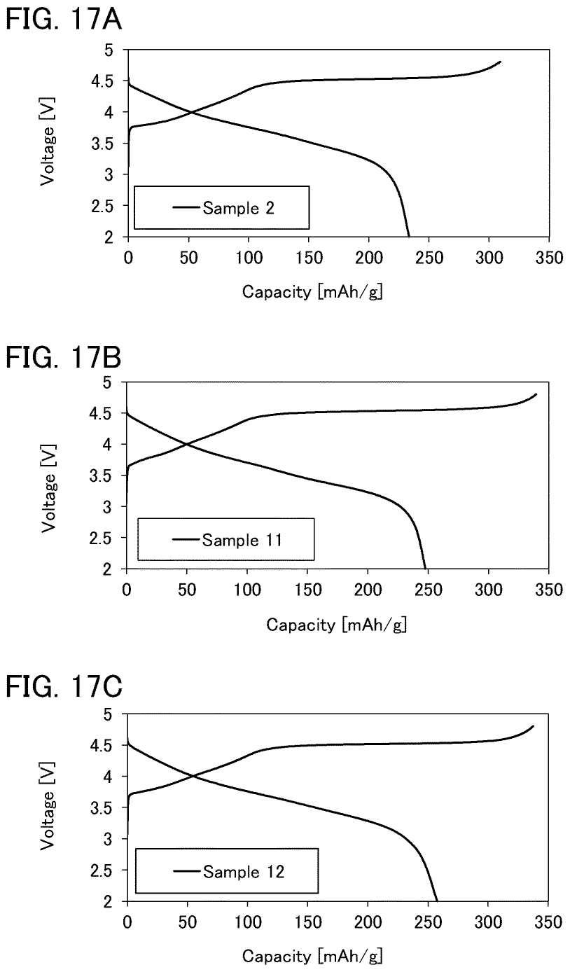

FIGS. 17A to 17C show charge and discharge curves in the first cycle of the half cells using the positive electrode active material particles of Samples 2, 11, and 12.

The initial discharge capacity of Sample 2 in FIG. 17A is 233.4 mAh/g; Sample 11 in FIG. 17B, 247.6 mAh/g; and Sample 12 in FIG. 17C, 257.8 mAh/g.

As observed in the SEM image, Sample 2 had an increase in particle size and thus probably had a higher internal resistance and a lower initial discharge capacity than the other samples. Although the particle size of Sample 11 was the smallest, the initial discharge capacity was lower than 250 mAh/g, which is probably because of insufficient heating temperature and/or time. Sample 12 shows an initial discharge capacity exceeding 250 mAh/g because the sample was fabricated through heating at an appropriate heating temperature and/or for an appropriate heating time in the whole formation process and was inhibited from having an increase in particle size.

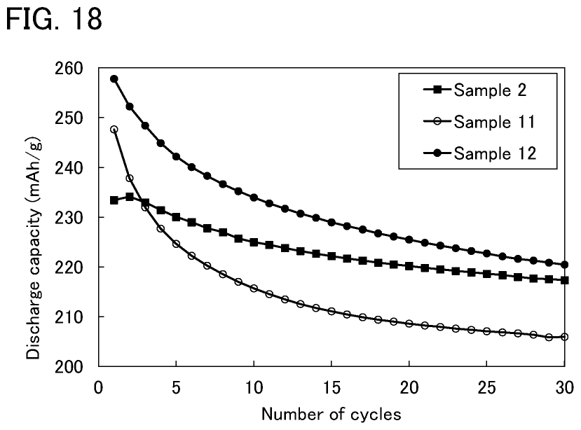

FIG. 18 shows charge and discharge cycle performances of the half cells using the positive electrode active material particles of Samples 2, 11, and 12. The discharge capacity of Sample 2 after 30 cycles was 217.3 mAh/g; Sample 11, 205.9 mAh/g; and Sample 12, 220.4 mAh/g. Sample 12 exhibited a particularly high discharge capacity over 215 mAh/g even after 30 cycles.

As described above, it has been found that the lithium-rich positive electrode active material particle containing magnesium and fluorine as the additive elements and having high magnesium and fluorine concentrations in the shell enables a high discharge capacity and a high cycle performance. In particular, Sample 12 subjected to the first heating at 900° C. was inhibited from having an increase in particle size and exhibited a high discharge capacity owing to the heating at the appropriate heating temperature and/or for the appropriate heating time.

This application is based on Japanese Patent Application Serial No. 2025-055623 filed with Japan Patent Office on Mar. 28, 2025, the entire contents of which are hereby incorporated by reference.

What is claimed is:

1. A method for forming a positive electrode active material particle, the method comprising:
mixing a lithium source and an M source to form a first mixture;
heating the first mixture at higher than or equal to 850° C. and lower than 950° C. to synthesize a first composite oxide;
mixing the first composite oxide and an additive element source to form a second mixture; and
heating the second mixture at higher than or equal to 850° C. and lower than or equal to 950° C.,
wherein M is one or more selected from Mn, Ni, Co, Cr, Mo, Nb, V, Fe, Ti, and Ru, and
wherein the additive element source comprises a fluorine source and a magnesium source.

2. The method for forming a positive electrode active material particle, according to claim 1,
wherein the fluorine source is lithium fluoride, and
wherein the magnesium source is magnesium fluoride.
